(19) United States
(12) Patent Application Publication
(10) Pub. No.: US 2026/0289031 A1
(43) Pub. Date: Sep. 24, 2026

(54) SYSTEM

(71) Applicant: SoftBank Group Corp., Tokyo (JP)

(72) Inventor: Hozumi TAUCHI, Tokyo (JP)

(73) Assignee: SoftBank Group Corp., Tokyo (JP)

(21) Appl. No.: 19/550,323

(22) Filed: Feb. 26, 2026

Related U.S. Application Data
(60) Provisional application No. 63/773,630, filed on Mar. 18, 2025.

(51) Int. Cl. G06F 30/13; G06F 30/27; G06F 111/06; G06Q 50/16

(52) U.S. Cl. CPC G06F 30/13; G06F 30/27; G06Q 50/165; G06F 2111/06

(57) ABSTRACT

A system includes a processor that is configured to receive, via a land information input unit, data regarding land including at least a size, a shape, and an orientation of the land, provide, via a condition setting unit, an interface through which a user inputs design conditions including at least required facilities, legal conditions, and other design conditions, generate, via a layout generation unit, a plurality of layout plans based on the received land information and the input design conditions, visualize the plurality of layout plans as three-dimensional models, calculate, via an algorithm, an optimal arrangement for the layout plans by taking into account a tolerance degree of the design conditions, and present the generated plurality of layout plans to the user.

### CROSS-REFERENCE TO RELATED APPLICATION

This application claims the benefit of U.S. Provisional Application No. 63/773,630 filed on Mar. 18, 2025, pursuant to 35 U.S.C. § 119 (e), the entire contents of which are incorporated herein by reference.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional architectural design workflows for residential and commercial buildings require an architect to manually integrate multiple types of information, including land characteristics, legal regulations, client requirements, and interior finishing options. In many cases, an architect must separately perform land analysis, floor plan drafting, material selection, and interior visualization using disconnected tools or manual procedures. As a result, the process of generating multiple floor plan proposals, adjusting them according to changing conditions, and presenting them to a client in a visually comprehensible form is time-consuming and labor-intensive. Furthermore, conventional systems often lack an integrated mechanism for automatically optimizing room layouts based on land information and design constraints, and they do not sufficiently support the presentation of realistic three-dimensional images that reflect selected wall and floor materials as well as interior design styles. This leads to difficulties for clients in understanding the final appearance of a proposed design and reduces the efficiency and quality of communication between architects and clients. Accordingly, there is a need for a system that can, in an integrated manner, receive land information and design conditions, automatically generate and optimize multiple layout plans, apply selected materials, and produce realistic three-dimensional images for interior design proposals, thereby improving efficiency, accuracy, and client comprehension in the design process.

### SUMMARY

In order to solve the above-described problems, the present invention provides a system comprising a processor configured to execute a series of integrated functions as defined in the claims. According to one aspect, the processor is configured to receive, via a land information input unit, data regarding land including at least a size, a shape, and an orientation of the land, and to provide, via a condition setting unit, an interface through which a user inputs design conditions including at least required facilities, legal conditions, and other design conditions. The processor is further configured to generate, via a layout generation unit, a plurality of layout plans based on the received land information and the input design conditions, to visualize the plurality of layout plans as three-dimensional models, to calculate, via an algorithm, an optimal arrangement for the layout plans by taking into account a tolerance degree of the design conditions, and to present the generated plurality of layout plans to the user. According to another aspect, the processor is configured to provide a wall material selection unit and a floor material selection unit that present, to the user, options for wall materials and floor materials based on reference knowledge supplied by manufacturers so as to reflect latest materials and designs, to apply materials selected by the user to the generated layout plans, and to enable the user to visually confirm the layout plans with the applied materials. According to a further aspect, the processor is configured to provide an image generation unit that utilizes an image generation artificial intelligence to propose interior designs based on the selected materials and the generated layout plans, to generate realistic three-dimensional images that take into account at least furniture placement and color balance, and to present the generated three-dimensional images to the user so that a client can concretely grasp an image of a completed interior. By these means, the system realizes an integrated design support environment that streamlines the entire workflow from land analysis and layout generation to material selection and interior visualization.

The term “system” refers to an integrated combination of hardware and software components that cooperatively perform the functions defined in the claims, including at least a processor and associated input, output, and storage units.

The term “processor” refers to one or more hardware processing units, such as a central processing unit (CPU), a graphics processing unit (GPU), or a specialized accelerator, that execute instructions to implement the functions and algorithms described in the claims.

The term “land information input unit” refers to a hardware and/or software component that receives and processes data regarding land, including at least land size, land shape, and land orientation, from a user or from external data sources.

The term “condition setting unit” refers to a hardware and/or software component that provides an interface or mechanism for a user to input design conditions, including at least required facilities, legal conditions, and other design conditions related to a building project.

The term “layout generation unit” refers to a hardware and/or software component that generates one or more building layout plans based on land information and design conditions, and that may use computational algorithms to optimize room arrangement and building configuration. The term “layout plan” refers to a representation of a building floor plan, including at least the positions, sizes, and relationships of rooms, corridors, and other architectural elements within a building structure.

The term “three-dimensional model” refers to a digital representation of a building or interior space in three spatial dimensions, including geometric shapes, spatial relationships, and optionally material or texture information, suitable for visualization on a display device. The term “algorithm” refers to a defined computational procedure or set of rules, which may include optimization techniques such as genetic algorithms, neural networks, or rule-based systems, for calculating an optimal or improved arrangement of building elements based on specified design conditions.

The term “tolerance degree of the design conditions” refers to a measure or parameter indicating the allowable range, flexibility, or priority of each design condition when optimizing a layout plan, such that some conditions may be relaxed or weighted differently in the optimization process.

The term “wall material selection unit” refers to a hardware and/or software component that presents, to a user, options for wall materials based on reference knowledge, and that receives user selections of wall materials to be applied to a layout plan or three-dimensional model. The term “floor material selection unit” refers to a hardware and/or software component that presents, to a user, options for floor materials based on reference knowledge, and that receives user selections of floor materials to be applied to a layout plan or three-dimensional model. The term “reference knowledge supplied by manufacturers” refers to information provided by material or product manufacturers, including at least material names, types, properties, design styles, availability, and recommended uses, which is used to present material options to the user.

The term “material” refers to a building or interior finish product, such as wall coverings, paints, tiles, wooden flooring, carpets, or other surface finishes, that can be applied to walls, floors, or other surfaces in a building design.

The term “image generation unit” refers to a hardware and/or software component that uses image generation artificial intelligence to create images of interior or architectural spaces based on layout plans, selected materials, and user-specified conditions.

The term “image generation artificial intelligence” refers to a machine learning system, such as a neural network-based model, configured to generate images or renderings of interior or architectural scenes in response to input data and prompts describing layout, materials, and design preferences.

The term “interior design” refers to a configuration and arrangement of elements within an interior space, including at least furniture placement, color schemes, materials, lighting, and decorative features, intended to satisfy functional and aesthetic requirements.

The term “furniture placement” refers to the positioning and arrangement of furniture items within a room or interior space, including their orientation and spatial relationships, in accordance with functional use and design objectives.

The term “color balance” refers to the overall visual harmony and distribution of colors within an interior space, including the relationship between wall colors, floor colors, furniture colors, and accent elements.

The term “user” refers to a person, such as an architect, designer, or other professional, who operates the system, inputs land information and design conditions, selects materials, and reviews layout plans and generated images.

The term “client” refers to a person or entity for whom a building or interior design project is being created, and who reviews and evaluates the layout plans and generated images in order to understand and approve the final design.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

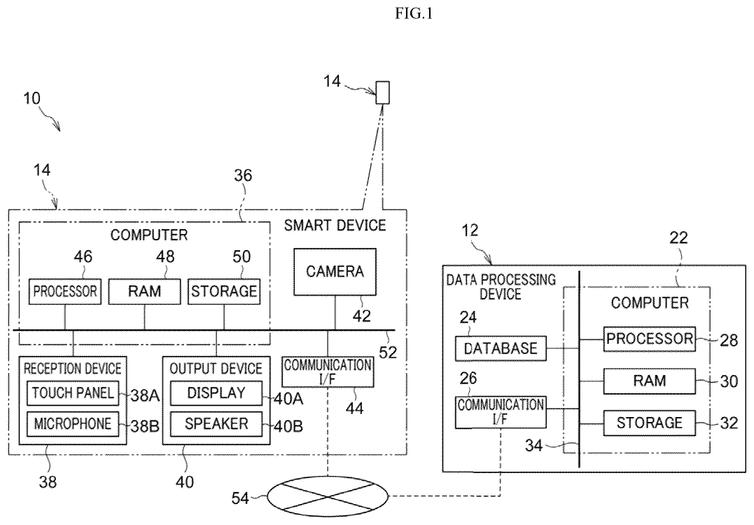

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12. The data processing device 12 includes a computer 22, a database 24, and a

communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

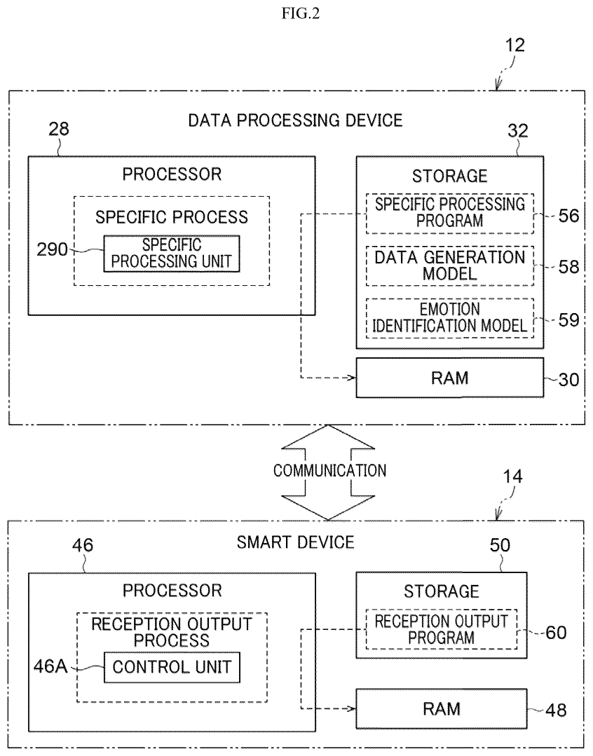

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional computer-implemented design support systems for building layout and interior planning typically operate as static drawing tools or rule-based configurators. In such systems, a processor merely renders manually created plans or performs limited constraint checking, while most optimization and visualization work must still be performed by a human designer. This leads to several technical problems in the field of computer technology applied to architectural design.

First, conventional systems do not efficiently integrate heterogeneous data such as site attributes, legal constraints, and user-specific habitation requirements into a unified computational representation that can be automatically optimized. As a result, the processor repeatedly executes separate, non-coordinated routines for geometry handling, rule validation, and visualization, which causes redundant memory access, fragmented data structures, and increased processing latency.

Second, conventional systems generally use deterministic, hand-crafted algorithms for layout suggestion, which are not well suited for high-dimensional constraint spaces and complex design objectives such as sunlight maximization, ventilation paths, and circulation quality. When a designer changes one constraint, the system often has to recompute the entire layout from scratch in a non-incremental manner. This leads to inefficient use of processor resources, poor responsiveness, and difficulty in iteratively refining solutions in real time.

Third, image generation for interior visualization is commonly performed by separate rendering engines or manual modeling workflows that are loosely coupled to the layout computation. In many cases, interior images are generated offline by human operators using external rendering software. The lack of an integrated, machine-interpretable pipeline between layout data, material selections, and image generation prevents the processor from exploiting advanced machine learning or generative models to automatically synthesize images that are consistent with underlying spatial and material data. This fragmentation results in additional data conversion overhead, inconsistent representations, and increased bandwidth usage between components. Fourth, while generative artificial intelligence models are known, conventional design systems do not tightly couple prompt-based generative models with structured three-dimensional model data and dynamic user feedback. Existing systems typically accept free-form prompts without contextual grounding in site attributes or layout geometry, causing unstable or irrelevant outputs.

Moreover, these systems rarely implement an iterative feedback loop at the processor level, in which user evaluation and correction prompts are fed back into the same computational pipeline to refine both layout candidates and interior imagery. Consequently, the processor cannot fully leverage generative models to optimize not only visual realism but also spatial consistency and constraint satisfaction.

Therefore, there is a need for an improved computer-implemented system and processing architecture in which a processor integrates site attribute acquisition, constraint modeling, evolutionary and machine-learning-based layout search, material-aware three-dimensional model generation, and generative artificial intelligence-based interior image synthesis into a unified, feedback-driven pipeline. Such a system should technically improve how the processor structures and transforms design data, reduce redundant computations, and enhance responsiveness and scalability when handling iterative design updates and prompt-based image generation.

The specific processing by the specific processing unit 290 of the data processing device 12 in Example 1 is realized by the following means.

The present invention provides a server comprising a processor configured to acquire site attribute information including environmental information from a user, generate site attribute data including position information and surrounding environment information by using a position information acquisition device and a map information acquisition device, acquire regulatory condition information and habitation requirement information from the user and generate design constraint data by using the regulatory condition information and the habitation requirement information, input the site attribute data and the design constraint data to a search process including an evolutionary computation process and a machine learning process to calculate a plurality of layout candidates and calculate a suitability score for each layout candidate on the basis of an evaluation index to extract at least one selected layout candidate, generate solid shape data on the basis of the at least one selected layout candidate and generate three-dimensional model data representing a building space by using the solid shape data, provide the three-dimensional model data to a display terminal, obtain, on the basis of attribute information relating to building finish materials stored in a material information storage device, candidates relating to wall finish materials and floor finish materials and present the candidates to the user, acquire selection operations of the wall finish materials and the floor finish materials from the user and associate attribute information corresponding to the selected finish materials with the three-dimensional model data, apply the attribute information to the three-dimensional model data and generate updated three-dimensional model data in which the finish materials are reflected, acquire a prompt sentence including an instruction sentence obtained by a text input operation from the user, input the prompt sentence, spatial configuration information included in the three-dimensional model data, and finish material attribute information as input conditions to a generative artificial intelligence model and cause the generative artificial intelligence model to generate interior representation image data including furniture arrangement and color composition, present the generated interior representation image data to the display terminal, and acquire evaluation information and a correction prompt sentence from the user, update the input conditions for the generative artificial intelligence model on the basis of the evaluation information and the correction prompt sentence, and regenerate the interior representation image data. This enables an integrated and technically improved processing pipeline in which the processor represents site attributes, constraints, layout candidates, material selections, and generative model prompts in a coordinated data structure, reuses intermediate results across evolutionary search and image synthesis, reduces redundant computation and memory transfers, and provides responsive, feedback-driven refinement of both three-dimensional layouts and interior images in a manner that enhances the overall performance and capability of the computer system.

The term “site attribute information” refers to information describing a geographic site, including at least land size, land shape, orientation, position information, and surrounding environment information such as neighboring structures and environmental conditions. The term “environmental information” refers to information relating to physical surroundings of a site, including at least neighboring buildings, landscape features, sunlight conditions, and other environmental factors relevant to building design.

The term “position information” refers to information indicating a geographic location of a site, including at least coordinate information obtained from a position information acquisition device. The term “surrounding environment information” refers to information relating to an area around a site, including at least map data, zoning information, and characteristics of adjacent spaces.

The term “site attribute data” refers to structured data generated by a processor based on site attribute information, including at least position information and surrounding environment information suitable for computational processing.

The term “position information acquisition device” refers to any hardware and associated software configured to obtain geographic position information, including but not limited to a location sensor, a positioning receiver, or a location acquisition module.

The term “map information acquisition device” refers to any hardware and associated software configured to obtain map information, including but not limited to a map database access module or an interface to a map information service.

The term “regulatory condition information” refers to information indicating constraints imposed by regulations, including at least height limits, floor-area ratios, and other building code or zoning restrictions.

The term “habitation requirement information” refers to information indicating requirements and preferences of occupants, including at least desired room configuration, number of rooms, usage of spaces, and comfort requirements.

The term “design constraint data” refers to structured data generated by a processor based on regulatory condition information and habitation requirement information, the structured data representing constraints used for layout computation.

The term “search process” refers to a computational process that explores a solution space of layout candidates, and includes at least an evolutionary computation process and a machine learning process.

The term “evolutionary computation process” refers to a computational process that generates and updates candidate solutions based on mechanisms analogous to natural evolution, including at least selection, crossover, and mutation operations.

The term “machine learning process” refers to a computational process using a trained model to evaluate or generate data, the trained model being obtained by learning from training data and configured to output evaluation values or features for layout candidates.

The term “layout candidate” refers to a representation of a possible arrangement of building spaces, including at least spatial positions, shapes, and functions of rooms and circulation paths.

The term “evaluation index” refers to a quantitative or qualitative measurement used to evaluate layout candidates, including at least indices related to sunlight, ventilation, regulatory compliance, or spatial efficiency.

The term “suitability score” refers to a numerical or categorical value calculated for each layout candidate based on an evaluation index, used to rank or select layout candidates.

The term “selected layout candidate” refers to at least one layout candidate extracted from a plurality of layout candidates based on a suitability score.

The term “solid shape data” refers to geometric data representing three-dimensional volumetric elements of a building layout, including at least walls, floors, and ceilings.

The term “three-dimensional model data” refers to data representing a three-dimensional building space, including at least solid shape data, spatial relationships of elements, and display attributes suitable for rendering on a display terminal.

The term “display terminal” refers to any information processing apparatus configured to display three-dimensional model data or image data to a user, including but not limited to a portable terminal, a stationary terminal, or a display device.

The term “evaluation information” refers to information indicating a user's assessment of at least one selected layout candidate or generated image, including at least quality ratings, comments, or modification requests.

The term “correction condition information” refers to information indicating additional or changed constraints supplied by a user for updating layout candidates, including at least revised regulatory requirements or changed habitation requirements.

The term “material information storage device” refers to any storage device configured to store attribute information relating to building finish materials, including at least a memory, a storage medium, or a storage server.

The term “attribute information relating to building finish materials” refers to information describing characteristics of finish materials, including at least type, texture, color, durability, maintenance characteristics, environmental characteristics, and cost range.

The term “wall finish material” refers to a surface finish applied to a wall portion of a building space, including at least coatings, panels, or coverings.

The term “floor finish material” refers to a surface finish applied to a floor portion of a building space, including at least boards, tiles, or sheets.

The term “updated three-dimensional model data” refers to three-dimensional model data in which attribute information of selected finish materials has been applied so that visual appearance of walls and floors reflects the selected finish materials.

The term “prompt sentence” refers to a natural language expression input by a user, including at least one instruction sentence, used as an input condition for a generative artificial intelligence model.

The term “instruction sentence” refers to a sentence included in a prompt sentence that explicitly indicates a desired condition or request, including at least a request relating to layout, style, or arrangement of interior elements.

The term “spatial configuration information” refers to information included in three-dimensional model data that defines arrangement and geometry of building spaces, including at least positions, shapes, and connectivity of rooms and structural elements.

The term “finish material attribute information” refers to attribute information relating to finish materials that has been associated with three-dimensional model data, including at least color, texture, and material type information applied to surfaces.

The term “generative artificial intelligence model” refers to a trained model configured to generate data such as images on the basis of input conditions including a prompt sentence and structured information, the trained model being obtained through machine learning and capable of synthesizing new content.

The term “interior representation image data” refers to image data representing an interior space of a building, including at least visual depiction of furniture arrangement, color composition, and application of finish materials.

The term “furniture arrangement” refers to a layout of furniture items within an interior space, including at least positions, orientations, and relationships between furniture items. The term “color composition” refers to a combination and distribution of colors used in an interior space, including at least colors of walls, floors, furniture, and accessories. The term “correction prompt sentence” refers to a prompt sentence input by a user after viewing generated interior representation image data, the prompt sentence including corrections or additional requests used to update input conditions for the generative artificial intelligence model.

In one embodiment, a system includes a server and at least one terminal connected via a communication network. The server includes at least one processor, a memory, a storage device, and a network interface. The terminal includes at least one processor, a memory, a display, an input device such as a touch panel or keyboard, a position information acquisition device such as a GPS receiver, and a network interface.

Server executes program modules stored in the memory to implement site attribute acquisition, constraint modeling, layout search using evolutionary computation and machine learning, three-dimensional model generation, material mapping, and image synthesis using a generative AI model. Terminal executes a client application to acquire user inputs, display three-dimensional models and images, and communicate with the server.

Terminal operates an operating system such as a general-purpose mobile operating system or a desktop operating system. Terminal runs a client application implemented, for example, with a cross-platform application framework. Server operates a server operating system such as a general-purpose server operating system and runs backend software implemented, for example, in a general-purpose programming language with a web framework, a database access library, a three-dimensional processing library such as a mesh processing engine or three-dimensional modeling engine, and a machine learning framework such as a tensor computation library.

Server stores project data, site attribute data, design constraint data, layout candidate data, three-dimensional model data, material attribute data, and interior representation image data in a structured database, for example, a relational database. Server may store large binary data such as three-dimensional model files and image files in a storage service or file system.

Server generates a program that defines a data structure for site attribute data including at least a land identifier, coordinate values, land shape parameters, orientation, and surrounding environment descriptors obtained from map information. Server defines a data structure for design constraint data including at least numerical constraints such as height limit and floor-area ratio, categorical constraints such as usage type of rooms, and qualitative conditions encoded as parameterized values, for example, energy performance levels or comfort level indicators.

Server uses a position information acquisition device associated with the terminal to obtain coordinate values. Terminal reads latitude and longitude from a positioning module through an operating system location API. Terminal transmits the coordinate values to the server through a secure communication protocol. Server uses a map information acquisition device, implemented as an interface to a map information service, to query digital map data, zoning data, and environment descriptors around the coordinate values. Server transforms the external map data into normalized surrounding environment information, for example, encoded as a set of feature vectors representing building density, obstruction directions, and approximate sunlight exposure patterns.

User operates the terminal to input land size, land shape, and orientation information through an input screen. Terminal aggregates the user inputs with the coordinate values and the surrounding environment information into a site attribute information structure. Terminal transmits the site attribute information to the server.

User operates the terminal to input regulatory condition information and habitation requirement information. For example, user may input a height limit, a floor-area ratio, a required number of rooms, a desired number of floors, and a requirement for a home office space. Terminal transforms the textual and numerical inputs into a structured condition representation. Terminal transmits the regulatory condition information and habitation requirement information to the server. Server converts the received information into design constraint data by mapping qualitative descriptions into numerical parameters, such as minimal area per room, daylight priority weight, and circulation efficiency weight.

Server constructs a layout search model in memory. Server divides the building footprint into a continuous or discretized coordinate system. Server encodes each layout candidate as a genome vector or parameter set that includes at least room boundary coordinates, room usage types, window placements, and door connections. Server stores the layout candidates as data records linking genome vectors with derived geometric objects.

Server configures an evolutionary computation process. Server initializes a population of layout candidates by sampling feasible genome vectors that satisfy basic constraints derived from design constraint data. Server defines a fitness function that computes multiple evaluation indices. For example, server computes a daylight index using orientation, window orientation, and obstruction information obtained from surrounding environment information; server computes a circulation index using path length and number of turns between key rooms; server computes a legal compliance index from floor-area ratio, building height, and setback distances; and server computes a space utilization index from ratio of usable area to total area.

Server implements the fitness function using numerical operations over the geometric representation of each layout candidate. Server computes distances, areas, adjacency relationships, and visibility graphs using geometric algorithms. Server aggregates the individual indices into a suitability score using a weighted sum or a multi-objective ranking method, and stores the suitability score with each layout candidate.

Server performs selection, crossover, and mutation operations on the layout candidates. Server selects high-score candidates and combines portions of their genome vectors to generate new candidates. Server applies mutations by perturbing room boundaries, swapping room functions, and adjusting window positions. Server iteratively updates the population and re-evaluates suitability scores. Because the server encodes all layouts in compact genome vectors and reuses intermediate geometric computations, server reduces memory transfers and improves cache locality compared to conventional systems that recompute full geometry from scratch for each trial.

Server further configures a machine learning process to refine evaluation of layout candidates. In one embodiment, server uses a neural network model trained to predict an additional comfort score or usability score from features derived from layout candidates. Server extracts feature vectors from each layout candidate, including room adjacency matrices, room area distributions, window-to-wall ratios, and path statistics. Server uses a neural network model such as a multi-layer perceptron or a graph neural network with weight parameters stored in memory. Server performs a forward pass of the neural network by multiplying the feature vectors with weight matrices, applying non-linear activation functions, and computing an output score. Server combines the neural network output with the deterministic evaluation indices to obtain a final suitability score.

Server trains the neural network model in advance or in an online manner using training data comprising historical layout examples with target scores. Server minimizes an error function such as mean squared error or cross-entropy between network outputs and target scores. Server updates weight parameters using an optimization method such as stochastic gradient descent or Adam, computing gradients by backpropagation through the network layers. Server may perform data augmentation by perturbing training layouts while preserving key relationships to improve model robustness. Because server integrates the neural network evaluation into the evolutionary computation loop, server can concentrate search in regions of the solution space likely to yield high user satisfaction while reducing the number of layout candidates that require full geometric evaluation.

Server stops the evolutionary computation process when a termination condition is met, for example, a fixed number of generations or convergence of suitability scores. Server selects at least one layout candidate with the highest suitability score as a selected layout candidate. Server converts the selected layout candidate into solid shape data by generating explicit three-dimensional representations of walls, floors, and ceilings based on the geometric parameters. Server uses a three-dimensional modeling engine to construct mesh data including vertices, edges, faces, and material slots. Server stores the three-dimensional model data in a standardized format suitable for rendering by the terminal, such as a generic three-dimensional geometry format.

Server transmits metadata for the three-dimensional model data to the terminal. Terminal downloads the three-dimensional model data and renders the model on the display using a three-dimensional graphics library, allowing user to rotate, zoom, and inspect the layout. User provides evaluation information and requests for modification by interacting with the terminal, for example, specifying that a living room should be larger or that more storage is required. Terminal converts the evaluation information into correction condition information and transmits the correction condition information to the server.

Server interprets the correction condition information as adjustments to design constraint data. Server updates constraint parameters, such as minimum area for a particular room or weight of a daylight index. Server re-executes the evolutionary computation process using the updated design constraint data and, optionally, using the previously found high-score candidates as seeds. This re-use of prior candidates and cached geometric computations reduces processing time for iterative refinements and provides a technical improvement in responsiveness compared to recomputing layouts from scratch.

Server maintains a material information storage device containing attribute information relating to building finish materials. Server stores for each material a set of attributes, such as type, color, texture reference, reflectance, roughness, durability rating, maintenance requirement, environmental certification level, and typical cost range. Server organizes the material attribute information into indexed tables so that candidate materials can be efficiently retrieved by attribute filters.

Terminal sends a request for material candidates related to walls and floors. Server retrieves from the material information storage device a list of wall finish material candidates and floor finish material candidates matching general project conditions, for example, intended usage, budget constraints, and environmental requirements. Server transmits the list to the terminal. Terminal displays material thumbnails and attribute summaries. User selects specific materials for walls and floors of particular rooms or the entire building. Terminal transmits identifiers of the selected finish materials to the server.

Server associates the selected materials with the three-dimensional model data by mapping material identifiers to material slots on mesh surfaces representing walls and floors. Server updates the three-dimensional model data to include material attribute information, such as color and texture references, allowing the terminal renderer to display realistic surfaces. In some embodiments, server directly applies texture coordinates, normal vectors, and shading parameters to the mesh data to minimize client-side processing. By embedding material information in the three-dimensional model data, server reduces the amount of separate material metadata that must be transmitted and parsed, thus lowering communication load and improving rendering setup speed at the terminal.

User operates the terminal to input a prompt sentence including at least one instruction sentence. For example, user may input the following prompt sentences in text form:

“Please propose a living room facing south that maximizes sunlight while keeping a spacious circulation path.”

“Please propose a modern interior style using eco-friendly materials for the walls and floors, with a calm neutral color palette.”

“Please propose a flexible floor plan that can adapt to changes in family structure, including a home office that can be converted into a guest room.”

“Please generate a 3D interior view of a 3LDK house with a bright south-facing living room, large windows for natural ventilation, and energy-efficient lighting.” Terminal transmits the prompt sentence together with a reference to the current three-dimensional model data to the server. Server parses the prompt sentence using natural language processing components. In one embodiment, server uses a language encoder model that converts the prompt sentence into an embedding vector representing semantic content. Server may also use rule-based parsing to detect explicit constraints in the text, such as “living room facing south” or “eco-friendly materials”, and aligns these constraints with structured design parameters.

Server prepares input conditions for a generative AI model. Server includes in the input conditions the text embedding of the prompt sentence, the spatial configuration information extracted from the three-dimensional model data, and the finish material attribute information. Spatial configuration information may be encoded as a low-resolution depth map, a segmentation map indicating surfaces such as walls and floors, or as a feature grid encoding room boundaries and opening locations. Finish material attribute information may be encoded as categorical tags per surface region.

In one embodiment, server uses a generative AI model implemented as a diffusion model. Server uses a neural network architecture comprising a text encoder, a U-Net-like network for image denoising, and a decoder. Server feeds the text embedding and spatial configuration features into a cross-attention module within the U-Net network. Server initializes latent image tensors with random noise and iteratively applies denoising steps conditioned on the text and spatial features. At each timestep, server computes predicted noise using convolutional layers, attention layers, and non-linear activations, and updates the latent tensor using a numerical integration scheme such as Euler or a more advanced sampler. After a fixed number of steps, server decodes the latent representation into an interior representation image.

In another embodiment, server uses a transformer-based generative model that receives both textual tokens and discrete spatial tokens derived from the three-dimensional model data, and outputs rasterized image tokens representing the interior. The model architecture includes self-attention layers, cross-attention layers, and feed-forward blocks. Server computes token embeddings, processes them through the transformer layers, and obtains token probabilities from which server samples or selects image tokens to construct the final image.

Server may pre-train the generative AI model using a training dataset comprising pairs of three-dimensional layouts, material assignments, prompt sentences, and ground-truth interior images. Server defines a loss function that may include reconstruction loss between generated and ground-truth images, perceptual loss based on feature differences computed in an auxiliary network, and regularization terms controlling style consistency and spatial alignment. Server updates model parameters through backpropagation and gradient-based optimization over many training iterations. By jointly conditioning on structured spatial information and textual prompts during training, server configures the generative AI model to generate images that are both visually realistic and spatially consistent with the layout and materials.

Server generates interior representation image data as output of the generative AI model. Server associates each image with metadata including the input prompt sentence, the selected layout candidate, camera parameters, and material configuration. Server stores the interior representation image data and transmits the images or thumbnails to the terminal. Terminal displays the images to the user. User evaluates the images and may input a correction prompt sentence such as “Make the living room more minimalist with fewer decorative items and increase built-in storage” or “Use slightly darker flooring while keeping the walls bright.” Terminal sends the correction prompt sentence and evaluation information to the server. Server updates input conditions to the generative AI model, for example, by modifying style parameters, adjusting color distributions, or re-weighting attention to specific phrases. Server may also update internal constraint parameters for layout or material selection when the correction prompt contains structural requests. Server regenerates interior representation image data using the updated input conditions, and transmits the updated images to the terminal.

Because server integrates evolutionary layout search, structured material mapping, and generative AI image synthesis within a unified data structure and processing pipeline, server can reuse spatial configuration information and material attribute information across different stages. Server avoids repeated conversion between incompatible formats and reduces redundant computations. For example, server maintains a canonical representation of room boundaries and material assignments that can be used both for eligibility checks in the fitness function and for generating segmentation maps required by the generative AI model. This sharing of intermediate representations reduces processing time, lowers memory bandwidth usage, and enables faster response to user interactions.

Moreover, server employs non-conventional processing order and coupling between modules. Instead of performing layout generation, visualization, and material mapping as independent tasks, server treats them as interdependent processes in which machine learning evaluation influences evolutionary candidate selection, and generative AI conditioning reflects the same spatial and material data used in layout computation. This interdependency enables server to achieve improved coherence between layout and interior depiction, reducing mismatch errors that would otherwise require manual correction.

Terminal and server cooperate to implement a feedback loop in which user evaluation and correction prompts modify the same underlying computational models rather than only changing superficial display parameters. Server adjusts layout search parameters and generative AI conditioning weights according to user feedback metrics, thereby adapting the model behavior to the specific project and progressively improving suitability of layouts and images. This adaptive computational process provides a technical improvement over static, rule-based systems that cannot dynamically refine their behavior based on ongoing user interaction.

In alternative embodiments, server may employ different machine learning architectures, such as convolutional neural networks, recurrent neural networks, or hybrid models, for evaluating layout candidates or generating images. Server may replace the diffusion-based generative AI model with a generative adversarial network including a generator and a discriminator. In such embodiments, server trains the generator to create interior representation images that the discriminator cannot distinguish from real images, using an adversarial loss function combined with reconstruction loss. Server configures the generator to receive both a prompt sentence embedding and structured spatial features, ensuring that generated images remain consistent with three-dimensional model data.

In another variation, server may deploy a graph-based layout evaluation model in which rooms and circulation elements are represented as nodes and edges in a graph, and a graph neural network computes node and graph-level embeddings used to predict comfort scores. By operating directly on graph structures, server can more efficiently capture relational properties such as adjacency and connectivity, leading to more accurate suitability scores and therefore more effective evolutionary search, which reduces the number of generations necessary to reach acceptable solutions.

Because the system uses these specific data structures, algorithms, and model architectures, and because server organizes processing into a tightly integrated pipeline that reuses intermediate results and conditions generative models on structured layout and material features, the invention provides technical effects such as improved processing speed, reduced memory and communication overhead, increased accuracy and consistency between layouts and interior images, and decreased error rates in regulatory compliance checks compared to conventional systems. The cooperation between server, terminal, and generative AI models is not a mere automation of human design operations, but a reconfiguration of computer-internal representations and algorithmic flows to achieve more efficient and effective computational design processing.

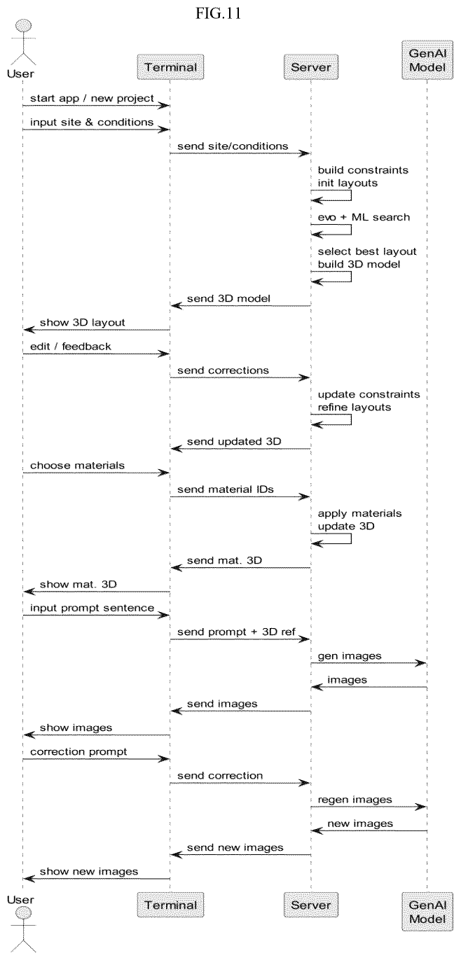

The following describes the processing flow using FIG. 11.

### Step 1:

Terminal initializes a design project and acquires site attribute information.

User starts a client application on the terminal and selects a command to create a new project.

User inputs land size, land shape, and orientation through graphical input components such as text boxes, dropdown lists, and on-screen drawing tools.

Terminal calls an operating system location API to obtain latitude and longitude from a position information acquisition device.

Terminal sends the latitude and longitude to an external map service and receives map data including zoning category and surrounding building information.

Input: user-entered land parameters and raw location coordinates; map service response.

Terminal merges the user-entered land parameters with the map response into a normalized site attribute information structure by converting text and coordinates into typed fields and feature flags, and outputs the site attribute information to the server via a request message.

### Step 2:

Server transforms the site attribute information into structured site attribute data.

Server receives the site attribute information from the terminal and parses a message body encoded in a structured format.

Server validates each parameter, for example, checking that land size is positive and that orientation is one of predefined codes.

Server queries a map information acquisition device or service using the received coordinates to refine surrounding environment information such as obstacle directions and approximate sunlight availability.

Input: raw site attribute information and additional map data.

Server converts the raw site attribute information and additional map data into site attribute data by mapping land shape, orientation, and environment descriptors into numeric features and categorical codes, and stores the site attribute data in a database as a record associated with a project identifier.

### Step 3:

Terminal acquires regulatory condition information and habitation requirement information. User operates the terminal to input regulatory conditions such as height limit, floor-area ratio, and setback requirements through dedicated input fields.

User further inputs habitation requirements such as required number of rooms, preferred number of floors, desired presence of a home office, and general style or comfort preferences. Terminal performs client-side validation to ensure that all required fields are filled and that numeric values fall within acceptable ranges.

Input: user-entered text and numeric values for regulatory and habitation conditions.

Terminal converts the mixed user inputs into structured regulatory condition information and habitation requirement information by mapping textual descriptions into enumerated types and numeric parameters, and outputs them to the server in a condition transmission message.

### Step 4:

Server generates design constraint data from regulatory condition information and habitation requirement information.

Server receives the condition transmission message and decodes the structured content.

Server maps each regulatory item and habitation requirement to internal constraint parameters, such as maximum building height, maximum total floor area, minimal area per room type, minimal window area per external wall, and weights for evaluation indices like daylight and circulation.

Input: regulatory condition information and habitation requirement information.

Server applies transformation rules and lookup tables to convert the received information into a design constraint data structure that encodes these parameters as numeric values and categorical codes, and stores the design constraint data in association with the corresponding project.

### Step 5:

Server initializes layout candidates and constructs an internal geometric model.

Server retrieves the site attribute data and design constraint data from the database.

Server defines a building footprint region in a coordinate system based on land shape and setbacks derived from regulations.

Server initializes a population of layout candidates by sampling room placements and sizes that satisfy minimal dimension constraints and fit within the building footprint.

Input: site attribute data and design constraint data.

Server converts the footprint, constraints, and sampled room configurations into genome vectors and initial layout candidate records, and outputs a structured population of layout candidates for use in an evolutionary computation process.

### Step 6:

Server evaluates layout candidates using deterministic geometric calculations.

Server iterates over each layout candidate in the current population.

Server constructs geometric representations of walls, rooms, and openings from the genome vectors by computing polygon coordinates and adjacency relations.

Server calculates evaluation indices such as daylight index, circulation index, and regulatory compliance index using geometric algorithms including area calculations, path searches, and visibility checks.

Input: population of layout candidates encoded as genome vectors.

Server transforms each genome vector into geometric objects and numerical indices, aggregates the indices into interim evaluation scores, and stores these scores together with each layout candidate record as output for later combination with machine learning scores.

### Step 7:

Server computes an additional evaluation score using a machine learning process.

Server extracts feature vectors from each layout candidate, for example, room adjacency matrices, area distributions, window-to-wall ratios, and path-length statistics.

Server loads a trained neural network model into memory and performs forward computation by multiplying the feature vectors with learned weight matrices, adding biases, and applying non-linear activation functions.

Server obtains an output value representing a comfort score or usability score for each layout candidate.

Input: feature vectors derived from layout candidate geometry.

Server converts the feature vectors into neural network inputs and computes predicted comfort scores, and outputs the comfort scores for combination with the deterministic evaluation scores.

### Step 8:

Server calculates a suitability score and selects at least one layout candidate.

Server combines the deterministic evaluation scores and the machine learning comfort scores for each layout candidate using a predefined aggregation function such as a weighted sum.

Server normalizes and ranks suitability scores across the population.

Server selects a subset of layout candidates with highest suitability scores as parents for the next generation and as potential outputs to the user.

Input: deterministic evaluation scores and machine learning comfort scores for all candidates. Server computes final suitability scores and generates a list of selected layout candidates that serve as both seeds for subsequent evolutionary steps and as input for three-dimensional model generation.

### Step 9:

Server performs evolutionary search operations to refine layout candidates.

Server applies selection, crossover, and mutation operators to the genome vectors of selected layout candidates.

Server combines parts of parent genome vectors to form new child candidates and perturbs parameters such as room boundaries or window positions to explore nearby configurations.

Input: selected layout candidates and their genome vectors.

Server transforms the selected genome vectors into new genome vectors through evolutionary operators, creates a new generation of layout candidates, and outputs the updated population for re-evaluation in subsequent iterations.

### Step 10:

Server generates three-dimensional model data from selected layout candidates.

After completion of evolutionary iterations, server chooses at least one final selected layout candidate with a highest suitability score.

Server converts geometric room and wall representations into three-dimensional mesh data by extruding wall outlines, placing floors and ceilings, and defining openings for windows and doors.

Server assigns material slots to different surface types (walls, floors, ceilings) and sets default visual parameters such as base colors and surface normals.

Input: final selected layout candidate geometry.

Server outputs three-dimensional model data in a rendering-ready format containing vertices, faces, transformation matrices, and material slot identifiers, and stores the three-dimensional model data for access by the terminal.

### Step 11:

Terminal receives and displays three-dimensional model data for user inspection.

Terminal downloads three-dimensional model data or associated URLs from the server.

Terminal loads the model into a three-dimensional rendering engine and displays a perspective view on the display.

User rotates, pans, and zooms the model using touch gestures or pointer operations. Input: three-dimensional model data and rendering commands from user interactions. Terminal transforms the model data and interaction events into rendered frames using a graphics pipeline and outputs interactive views, enabling user to visually assess the proposed layout.

### Step 12:

Terminal acquires user evaluation information and correction condition information. User reviews the displayed three-dimensional layout and determines that some aspects should be adjusted, such as enlarging a particular room or changing circulation paths.

User enters evaluation information and requested modifications via forms, sliders, or direct manipulation of graphical elements.

Input: user-provided qualitative comments and quantitative modification values.

Terminal converts these user inputs into structured evaluation information and correction condition information, for example by mapping “enlarge living room” to increased minimum area for that room type, and outputs the correction condition information to the server for updating layout search parameters.

### Step 13:

Server updates design constraint data and re-runs layout search in response to correction condition information.

Server receives the evaluation information and correction condition information from the terminal.

Server modifies existing design constraint data by updating parameters such as minimum area, index weights, or maximum corridor length according to the correction information.

Input: previous design constraint data and new correction condition information.

Server recalculates constraint parameter values and generates updated design constraint data, then re-executes the evolutionary search and evaluation processes using the updated design constraint data to produce revised selected layout candidates and revised three-dimensional model data as new output.

### Step 14:

Server provides material candidates for walls and floors to the terminal.

Terminal sends a request for finish material options to the server.

Server queries a material information storage device to retrieve attribute records for wall finish materials and floor finish materials that match general project parameters such as usage and budget.

Input: material query parameters associated with the project.

Server filters material records using database queries, constructs a list of candidate materials including IDs, names, texture references, and attribute summaries, and outputs the candidate lists to the terminal.

### Step 15:

Terminal acquires user selections of wall finish materials and floor finish materials. Terminal displays material lists as a gallery or table with thumbnails and attribute descriptions. User selects desired wall finish materials and floor finish materials for specific rooms or for the entire project by tapping or clicking on material entries.

Input: candidate material lists and user selection operations.

Terminal converts the user selections into a structured mapping from room or surface identifiers to selected material IDs, and outputs a material selection message to the server.

### Step 16:

Server applies selected materials to three-dimensional model data and generates updated three-dimensional model data.

Server receives the material selection message and parses the room or surface identifiers and selected material IDs.

Server retrieves the corresponding three-dimensional model data and associates each surface region with appropriate material attribute information such as color, texture references, and reflectance parameters.

Input: three-dimensional model data and mapping of surfaces to selected material IDs. Server modifies material slots in the model data to include the detailed material attributes and outputs updated three-dimensional model data in which the visual appearance of walls and floors reflects the selected finish materials.

### Step 17:

Terminal displays updated three-dimensional models with applied materials.

Terminal downloads the updated three-dimensional model data from the server.

Terminal re-loads the model into the rendering engine and uses the updated material attributes to apply textures and shading to the surfaces.

Input: updated three-dimensional model data containing material attributes.

Terminal renders the model with realistic wall and floor appearances and outputs the updated visualization to the user for confirmation or further changes.

### Step 18:

Terminal acquires a prompt sentence for generative AI-based interior image generation.

User decides to view photorealistic interior images and enters a prompt sentence through a text input field on the terminal.

User may type, for example, “Please propose a living room facing south that maximizes sunlight while keeping a spacious circulation path.” or “Please propose a modern interior style using eco-friendly materials for the walls and floors, with a calm neutral color palette.”

Input: raw textual prompt sentence provided by the user.

Terminal encapsulates the prompt sentence together with identifiers of the current three-dimensional model data and selected materials, and outputs this encapsulated information to the server as a generative AI request.

### Step 19:

Server prepares input conditions for the generative AI model from the prompt sentence and three-dimensional model data.

Server receives the generative AI request and extracts the prompt sentence and identifiers. Server retrieves spatial configuration information from the three-dimensional model data, such as room segmentation, camera viewpoints, and depth or surface maps, and retrieves finish material attribute information associated with surfaces.

Server encodes the prompt sentence into a text embedding using a language encoder model and encodes the spatial configuration and material attributes into feature maps or tokens.

Input: prompt sentence, three-dimensional model data, and material attribute information. Server transforms these inputs into a unified set of conditioning data for the generative AI model, including a text embedding vector and structured spatial-material feature representations, and outputs the conditioning data to the generative AI model execution module.

### Step 20:

Server executes the generative AI model to synthesize interior representation image data. Server initializes latent image tensors with random noise or a prior distribution.

Server repeatedly applies a neural network comprising convolutional and attention layers that take as input the current latent tensors and the conditioning data to predict noise components or token probabilities.

Server updates the latent tensors according to a predefined sampling or denoising schedule until the tensors converge to a coherent image representation.

Input: conditioning data including text embedding and spatial-material features, and initial latent tensors.

Server transforms the latent tensors into pixel values or image tokens and outputs interior representation image data depicting the interior space with furniture arrangement and color composition consistent with the layout and materials.

### Step 21:

Terminal receives and displays the generated interior representation image data.

Terminal downloads the generated images or thumbnail versions from the server.

Terminal arranges the images in a gallery view or as selectable thumbnails on the display. User taps an image to view a larger version and visually compares multiple generated variations.

Input: interior representation image data and user display commands.

Terminal converts the image data into renderable bitmaps and outputs visual representations on the display device, enabling user to assess the realism and suitability of the interior design.

### Step 22:

Terminal acquires evaluation information and a correction prompt sentence for further refinement.

User inspects the generated images and decides to request changes, such as more minimalist furniture or different color schemes.

User enters comments and a correction prompt sentence, for example, “Make the living room more minimalist with fewer decorative items and increase built-in storage.”

Input: user evaluation feedback and correction prompt sentence.

Terminal aggregates the feedback into structured evaluation information and retains the new correction prompt sentence, and outputs both to the server in a refinement request.

### Step 23:

Server updates input conditions and regenerates interior representation image data.

Server receives the refinement request and parses the evaluation information and correction prompt sentence.

Server adjusts internal conditioning parameters, such as style weights or color distribution preferences, and may augment the text embedding by combining the original prompt sentence with the correction prompt sentence.

Input: previous conditioning data and new evaluation information and correction prompt sentence.

Server recomputes conditioning data and re-executes the generative AI model with updated parameters to generate new interior representation image data, and outputs the regenerated images to the terminal for additional review.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional computer-implemented planning systems for construction or layout design typically separate numerical optimization from visual verification. A conventional processor generates a plan using rule-based or optimization logic, and then produces static drawings or simple three-dimensional views for manual review. When a user identifies a problem in the visual representation, the user must translate the visual feedback back into parameter changes, and the processor must rerun the planning logic. This loop is slow, largely manual, and error-prone.

Furthermore, conventional systems do not effectively exploit generative AI models in a way that structurally improves the underlying computational process. Existing uses of generative AI models mainly produce illustrative images or videos as a cosmetic add-on. The generated content is not semantically linked back into the planning data structures, so the system cannot automatically interpret AI-generated proposals, cannot version them as structured alternatives, and cannot use them to refine optimization constraints. As a result, the core computer functionality remains limited: the processor cannot close the loop between planning, visualization, AI-assisted exploration, and structured plan revision.

In addition, known systems lack a mechanism for automatically constructing rich, context-aware prompt sentences for generative AI models from internal planning data. Users must manually write prompts that may omit critical environment information, numerical constraints, and time-series work data. This leads to non-deterministic and often irrelevant AI outputs that do not align with the internal state of the system. The processor therefore cannot reliably use the generative AI outputs as part of a deterministic, auditable planning pipeline.

There is also a need to improve computer efficiency in handling complex spatiotemporal planning problems. Traditional systems maintain separate representations for three-dimensional spatial information, time-series work information, and safety or regulatory constraints. These representations are rarely synchronized with AI-generated visual alternatives. This fragmentation causes redundant computations, prevents automated comparison of multiple scenarios, and complicates version control. The processor is not configured to manage planning data, visualization data, prompt sentences, and AI proposals within a unified, machine-interpretable framework.

Accordingly, there is a need for an improved computer-implemented system and server that (i) automatically produces context-enriched prompt sentences and structured conditioning data for generative AI models from internal planning data, (ii) uses the generative AI model not only to visualize but also to propose alternative layouts and movement plans, and (iii) converts the AI-generated content back into structured, version-managed planning data. Such a system should technically improve the way the processor manages, updates, and verifies complex spatial and temporal plans, thereby enhancing the efficiency, reliability, and interactivity of computer-based planning.

The specific processing by the specific processing unit 290 of the data processing device 12 in Application Example 1 is realized by the following means.

The present invention provides a server comprising a processor configured to receive environment information including land information; set design conditions and work conditions; calculate a resource arrangement and a movement path plan based on the environment information and the design conditions; generate three-dimensional spatial information representing the resource arrangement and the movement path plan and convert the three-dimensional spatial information into visualization data; generate, based on the visualization data, a prompt sentence and associated condition data to be input to a generative artificial intelligence model; automatically add numerical information and constraint information relating to the environment information, the design conditions, the resource arrangement, and the movement path plan to the prompt sentence to generate an expanded prompt sentence; generate input data for the generative artificial intelligence model by combining the expanded prompt sentence with structured time-series work information and the three-dimensional spatial information; generate image information or video information by using the generative artificial intelligence model on the basis of the expanded prompt sentence and the associated condition data; output the generated image information or the generated video information as verification information for the resource arrangement and the movement path plan; analyze, in response to an instruction from a user, the generated image information or the generated video information to extract features corresponding to a resource arrangement region, a movement route, and equipment placement; associate the extracted features with the three-dimensional spatial information and the resource arrangement and the movement path plan; convert a result of the analysis into structured data of the resource arrangement and the movement path plan; register an alternative plan proposed by the generative artificial intelligence model as version-managed planning data; and update the resource arrangement and the movement path plan based on the structured data and enable adoption or rejection of the alternative plan in response to a selection by the user. This enables the processor to establish a closed-loop computational workflow in which internal planning data are transformed into context-rich prompts and conditioning data for a generative artificial intelligence model, AI-generated images or videos are produced in alignment with the internal state, and the AI-generated content is automatically interpreted back into structured, version-controlled planning data, thereby improving computer-based planning efficiency, reliability, and interactivity for complex spatiotemporal layouts.

The term “environment information” refers to information representing physical surroundings of a site, including at least land information such as size, shape, orientation, elevation, and positions of obstacles, and optionally including surrounding structures, roads, and other context data.

The term “land information” refers to information describing a parcel or region of land, including parameters such as area, boundary shape, orientation, height distribution, and positional relationships with nearby objects.

The term “design conditions” refers to constraints, requirements, and preferences used to determine a plan, including functional requirements, regulatory conditions, safety rules, and performance criteria for a layout or construction project.

The term “work conditions” refers to conditions relating to execution of tasks, including schedules, work procedures, resource availability, equipment usage constraints, and labor assignments.

The term “resource arrangement” refers to a spatial allocation of physical resources within an environment, including positions and extents of materials, equipment, storage areas, and other objects to be placed on a site.

The term “movement path plan” refers to a representation of one or more routes or trajectories along which workers, vehicles, or equipment move within an environment, including path geometry, timing, and usage constraints.

The term “three-dimensional spatial information” refers to data that explicitly represent objects and spaces in three dimensions, including coordinates, shapes, volumes, and spatial relationships among resources, paths, and environment features.

The term “visualization data” refers to data derived from three-dimensional spatial information that are formatted for rendering or display, including scene descriptions, geometry data, texture data, camera parameters, and annotation data.

The term “prompt sentence” refers to a natural-language text string that describes a desired output or scenario and is provided as an input instruction to a generative artificial intelligence model.

The term “associated condition data” refers to structured or semi-structured data that supplement a prompt sentence, including numerical parameters, constraint information, spatial descriptors, and time-series descriptors used to condition a generative artificial intelligence model. The term “generative artificial intelligence model” refers to a machine-learned model configured to generate new data, such as images or videos, based on input data including at least a prompt sentence and optionally conditioning data, and implemented using statistical or neural network techniques.

The term “image information” refers to digital data representing one or more still images, including pixel values, metadata, and any auxiliary information generated by a generative artificial intelligence model.

The term “video information” refers to digital data representing a sequence of images over time, including frame data, temporal metadata, and any auxiliary information generated by a generative artificial intelligence model.

The term “verification information” refers to data used to assess or validate a resource arrangement or a movement path plan, including visualization results, metrics, and annotations that allow a user or a processor to evaluate suitability or compliance.

The term “numerical information” refers to quantitative values related to environment information, design conditions, resource arrangement, or movement path plan, including distances, capacities, time durations, and limits.

The term “constraint information” refers to explicit conditions that restrict allowable configurations or behaviors, including safety distances, capacity limits, regulatory bounds, and logical dependencies among planning variables.

The term “expanded prompt sentence” refers to a prompt sentence that has been automatically supplemented by the processor with numerical information, constraint information, and other context derived from internal data, to form a richer instruction for a generative artificial intelligence model.

The term “structured time-series work information” refers to data representing work tasks and events over time in a machine-readable format, including task identifiers, start and end times, assigned resources, and temporal relationships.

The term “analysis” refers to processing performed by the processor on image information or video information, including feature extraction, segmentation, object detection, or other operations that interpret visual content into machine-readable attributes.

The term “structured data of the resource arrangement and the movement path plan” refers to data that represent resource arrangement and movement path plan in a defined schema, including identifiers, coordinates, relationships, and attributes suitable for storage, computation, and version control.

The term “resource arrangement region” refers to a spatial region identified as an area where one or more resources are placed or stored within the environment.

The term “movement route” refers to a geometric representation of a path along which a worker, vehicle, or equipment travels, including lines, curves, or networks connecting locations in an environment.

The term “equipment placement” refers to the position and orientation of equipment within a site, including heavy machinery, vehicles, tools, or other operational devices.

The term “alternative plan” refers to a variant of a resource arrangement and movement path plan that differs from an existing plan in at least one aspect, and that is proposed or derived, at least in part, from output of a generative artificial intelligence model.

The term “version-managed planning data” refers to planning data stored with explicit version identifiers and relationships, enabling tracking, comparison, rollback, and selection among multiple historical or alternative plans.

In one embodiment, a server cooperates with one or more terminals operated by a user to implement the claimed system. The server includes at least one processor, a main memory, a non-transitory storage device, and a network interface. The terminal includes at least one processor, a memory, a display device, and an input interface such as a touchscreen, keyboard, or pointing device. The server and the terminal are connected via a communication network such as a wired or wireless Internet connection.

The server executes system software such as an operating system and executes application software modules implementing functions for environment information management, planning computation, three-dimensional spatial information generation, prompt sentence generation, generative AI model interaction, image and video analysis, and version-managed planning data storage. The terminal executes software for user interaction, three-dimensional visualization, and communication with the server.

The server receives environment information including land information from external measuring devices and data sources. The server uses a data acquisition module implemented, for example, using a general-purpose programming language such as C++ or Python, and uses libraries such as a point cloud processing library and a geographic data library. The server receives point cloud data, image data, and coordinate data representing land size, shape, orientation, height distribution, and obstacle positions, and stores the received data in a database or file system in association with project identifiers.

The server converts the raw environment information into three-dimensional spatial information. The server executes filtering, down-sampling, and registration algorithms on the point cloud data to generate a unified three-dimensional terrain mesh. The server uses, for example, a triangulated mesh representation stored as vertices, edges, and faces, and associates attribute values such as height, slope, and occupancy flags with mesh elements. The server further links this three-dimensional spatial information to a coordinate reference system so that the terminal can later display the spatial information in a stable, real-world aligned perspective.

The server receives design conditions and work conditions from the terminal. The terminal presents forms and graphical user interface components to the user so that the user can enter or select functional requirements, safety constraints, resource availability, and schedule data. The terminal performs local input validation and transmits the design conditions and work conditions as structured records to the server via a communication protocol. The server stores these conditions as structured time-series work information and static constraint records.

The server calculates a resource arrangement and a movement path plan based on the stored environment information, design conditions, and work conditions. The server generates decision variables that represent potential positions of resource arrangement regions and potential movement routes on the three-dimensional terrain mesh. The server then applies optimization methods, such as linear or mixed integer programming, graph search, or heuristic algorithms, to compute a combination of resource arrangement and movement path plan that satisfies the constraints and optimizes objective functions such as distance, travel time, and congestion metrics.

The server represents the computed resource arrangement and movement path plan as three-dimensional spatial information and structured planning data. The server generates a scene graph or spatial index structure that contains nodes corresponding to resources, storage areas, machinery, and path segments, and associates each node with three-dimensional coordinates, orientation parameters, identifiers, and attribute metadata. The server then produces visualization data in a format suitable for rendering by the terminal, such as a three-dimensional scene description including geometry, texture references, and camera parameters.

The terminal receives the visualization data and renders the three-dimensional spatial information on the display device. The terminal executes a three-dimensional rendering engine to display the computed resource arrangement and movement path plan to the user from arbitrary viewpoints. The user inspects the layout, selects objects, and issues commands through the terminal interface. The terminal sends user instructions to the server for further processing.

The server generates a prompt sentence and associated condition data to be input to a generative AI model based on the visualization data and the internal planning data. The server constructs the prompt sentence in natural language so that the prompt sentence semantically describes the environment information, the design conditions, the resource arrangement, and the movement path plan. The server, for example, automatically incorporates numerical information and constraint information into the prompt sentence. The server produces associated condition data that encode three-dimensional spatial information, time-series work information, and constraint information in a structured format usable by the generative AI model.

In one embodiment, the server generates a base prompt sentence such as:

“Based on the current terrain information, generate an optimal material layout that reduces worker congestion near the main gate.” In another embodiment, the server generates a prompt sentence such as: “Generate a layout where the heavy machinery movements are minimized while keeping emergency evacuation routes clear.” In another embodiment, the server generates a prompt sentence such as:

“Propose a material placement that shortens the walking distance for rebar workers on the third week of construction.”

In a further embodiment, the server generates a prompt sentence such as:

“Simulate an emergency evacuation scenario and highlight safe and unsafe paths for workers.” The server does not simply pass the user-entered text to the generative AI model. Instead, the server expands the prompt sentence by automatically appending numerical environment parameters (for example, site dimensions, elevation ranges), quantitative design conditions (for example, maximum capacity values and safety distances), and detailed time-series work information (for example, task identifiers and time windows). This expansion is performed by a dedicated prompt construction module that reads structured data from the database, converts them into textual phrases, and inserts them into the prompt sentence according to a predetermined template. As a result, the input to the generative AI model is consistent with the internal computational state and is reproducible.

The server loads and executes the generative AI model using hardware that includes at least one graphics processing unit. In one embodiment, the generative AI model is a diffusion-based generative model for images or videos, implemented as a deep neural network with a U-shaped encoder-decoder architecture and attention layers. The server stores trained model parameters in non-transitory memory and performs inference by iteratively denoising a latent representation conditioned on the expanded prompt sentence and the associated condition data. The server uses gradient-free inference execution at runtime; training may have been performed beforehand using supervised or self-supervised learning with a loss function such as a mean squared error or a perceptual loss between generated images and ground truth images.

In further embodiments, the server may use other generative AI model architectures, such as transformer-based models, generative adversarial networks, or hybrid models that combine convolutional networks with attention mechanisms. The server adapts the conditioning input to each architecture; for example, the server inputs depth maps or segmentation maps derived from the three-dimensional spatial information into specific channels of the model, and inputs the tokenized prompt sentence into a text encoder sub-network.

The server generates image information or video information by applying the generative AI model to the expanded prompt sentence and the associated condition data. The server performs tensor computations on the GPU to produce multiple candidate outputs. The server applies post-processing algorithms such as color normalization, resolution scaling, and overlay of visual indicators corresponding to safety zones or path categories. The server then stores the generated image information or video information in a storage device and registers metadata including the prompt sentence, model version, and evaluation metrics.

The terminal retrieves the generated image information or video information and presents them to the user as verification information for the resource arrangement and the movement path plan. The terminal may display the generated images side by side with the original three-dimensional visualization or overlay them with interactive elements that allow the user to inspect corresponding positions in the three-dimensional scene.

The server analyzes the generated image information or video information in response to an instruction from the user. The server executes an analysis module comprising a feature extraction pipeline. In one embodiment, the server uses a convolutional neural network configured for semantic segmentation to identify regions in the images that correspond to resource arrangement regions, movement routes, and equipment placement. The server may also use classical computer vision techniques, such as edge detection, line extraction, and template matching, to refine the segmentation results and improve spatial alignment with the existing three-dimensional spatial information.

The server converts the results of the analysis into structured data of the resource arrangement and the movement path plan. For example, the server maps segmented regions in an image to object identifiers in the scene graph by projecting image coordinates back to three-dimensional coordinates using known camera parameters and depth information. The server then determines new or adjusted positions of resource arrangement regions or movement routes suggested by the generative AI model and stores these positions as candidate planning data in a database table. The server maintains version-managed planning data by assigning version identifiers and storing links between original plans and alternative plans.

The server registers an alternative plan proposed by the generative AI model as version-managed planning data. The server not only stores the alternative plan as image information, but also stores a structured representation including resource identifiers, coordinates, path segments, and constraint status. The server allows the user to select, through the terminal, whether to adopt or reject the alternative plan. When the user adopts the alternative plan, the server updates the active resource arrangement and movement path plan with data from the selected version and recalculates derived metrics such as travel distances or congestion indices.

The server thereby establishes a closed-loop computational workflow in which environment information and planning data are transformed into three-dimensional spatial information and visualization data, automatically converted into expanded prompt sentences and associated condition data, used by a generative AI model to produce image and video outputs, and further interpreted back into structured planning data. This workflow improves computer technology by reducing the need for manual translation between visual verification and structured plan modification, by enabling deterministic and auditable integration of generative AI outputs into planning logic, and by optimizing storage and retrieval of multiple versions of planning data. The server achieves processing speed improvement by using structured representations and indexed spatial databases for environment information and planning data, so that the server can rapidly assemble context information for prompt construction and rapidly map features extracted from images back to the correct spatial entities. The server improves accuracy by synchronizing three-dimensional spatial information, time-series work information, and constraint information in a unified data model, thereby ensuring that the generative AI model receives complete and consistent conditioning inputs. The server reduces communication load by transmitting compressed visualization data and encoded planning updates instead of sending raw point clouds or full-resolution image sequences for every update.

The server uses learning-based models and rule-based modules in combination. In one embodiment, the server applies rule-based filters after analysis of the image information or video information, checking whether a proposed resource arrangement violates any design conditions or work conditions. The server applies non-conventional rules specific to the integration of generative AI outputs, such as discarding candidate layouts that are visually plausible but conflict with three-dimensional clearance requirements or exceed maximum travel time thresholds derived from the structured time-series work information. These rules are applied at the server side, in contrast to conventional systems where human users manually interpret and filter visual suggestions.

The server performs training of the generative AI model and the analysis model with datasets that include pairs of environment information, planning data, and ground truth visualizations. The server uses an error function, such as a combination of pixel-wise differences and structural similarity metrics, to update model weights via backpropagation. The server may employ data augmentation techniques such as random rotations, scaling, noise injection, and partial occlusions to improve generalization of the models. During runtime, the server does not repeat training but uses the previously trained models to carry out inference and analysis efficiently. The terminal supports multiple modes of operation. In one mode, the terminal only displays the server-generated visualizations and generative AI results and accepts user approvals or rejections. In another mode, the terminal allows the user to manually modify the resource arrangement or movement path plan by dragging objects in the three-dimensional view or by editing parameters in forms. The terminal sends these modifications to the server, and the server integrates them into the version-managed planning data. This multi-modal interaction enhances usability while maintaining the central role of the server in maintaining data consistency and executing computationally intensive algorithms.

The described system provides a technical effect beyond automation of human mental steps. The server improves the functioning of the computer system by introducing a specific data structure for three-dimensional spatial information, a specific method for constructing prompt sentences with embedded numerical and constraint data, a specific integration mechanism between generative AI outputs and planning data, and a version-managed repository for alternative plans.

These features allow the server to perform complex spatiotemporal planning tasks with greater speed, precision, and robustness than conventional systems that rely exclusively on manual interpretation of drawings or non-integrated visualization tools.

Alternative embodiments are possible. In one embodiment, the server may use a different type of generative AI model, such as a transformer-based text-to-video model, conditioned on the same expanded prompt sentence and three-dimensional spatial information. In another embodiment, the server may separate the generative AI model into a text encoder and an image decoder, with the server using different hardware accelerators for each part to improve throughput. In another embodiment, the server may implement different algorithms for resource arrangement and movement path plan calculation, such as rule-based heuristics or reinforcement learning, while still using the same closed-loop integration with the generative AI model described above. The system is not limited to construction sites and may be applied to other environments where resource arrangement and movement path planning are important, such as manufacturing plants, logistics warehouses, or outdoor event sites. In all such applications, the server, the terminal, and the generative AI model operate in substantially the same manner: the server receives environment information, calculates spatial plans, constructs enriched prompt sentences and associated condition data, generates images or videos, analyzes them to extract structured data, and manages multiple plan versions in a unified data structure, while the terminal provides visualization and interactive control to the user.

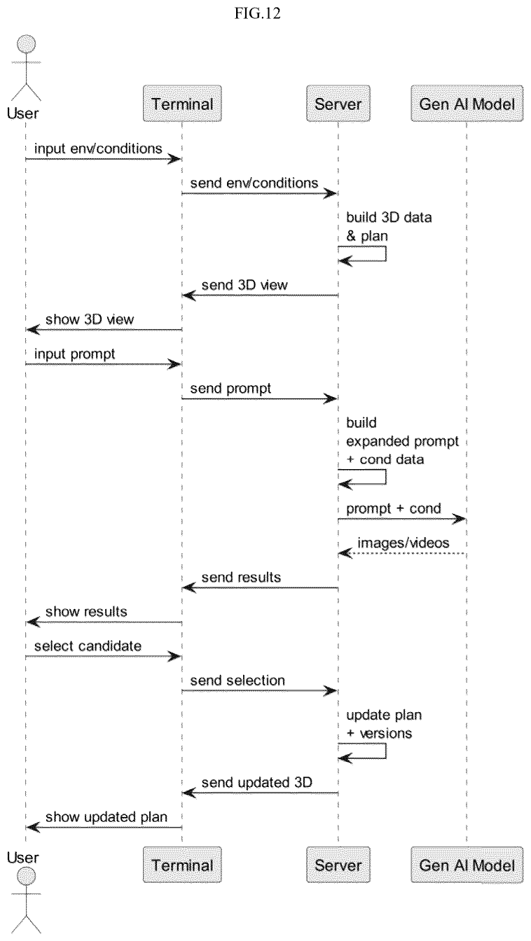

The following describes the processing flow using FIG. 12.

### Step 1:

Server receives environment information including land information as input.

Server obtains point cloud data, image data, and coordinate data from external measurement devices or pre-stored files, and the server writes these data into a structured storage such as a database or a file system.

Server performs basic validation on the input, including format checking, coordinate range checking, and completeness checks, and the server discards or flags invalid records.

Output of Step 1 is validated raw environment data associated with a project identifier. Step 2:

Server transforms the validated raw environment data into unified three-dimensional spatial information as input to subsequent planning.

Server applies noise filtering and down-sampling to the point cloud data, then executes registration algorithms to merge multiple scans into a single coordinate system.

Server computes a terrain mesh and associates attributes such as height, slope, and occupancy flags with each mesh element by performing geometric computations on the point data.

Output of Step 2 is a structured three-dimensional spatial representation stored as a terrain mesh and attribute tables.

### Step 3:

Server receives design conditions and work conditions as input from the terminal.

Terminal provides input screens for schedule parameters, safety distances, resource types, and work procedures, and the terminal sends these as structured messages to the server.

Server parses the structured messages, converts them into internal records for tasks, constraints, and resources, and stores them in a planning database.

Output of Step 3 is a set of design condition records and work condition records linked to the project and ready for planning computation.

### Step 4:

Server calculates a resource arrangement and a movement path plan using the three-dimensional spatial information and the condition records as input.

Server defines decision variables representing candidate storage locations and route segments on the terrain mesh, and the server constructs an optimization model with objective functions and constraints.

Server runs an optimization solver or heuristic algorithm that iteratively evaluates candidate solutions, computes cost metrics such as travel distance and congestion, and selects a solution that satisfies constraints and improves the objective.

Output of Step 4 is a computed resource arrangement and movement path plan represented as coordinates, identifiers, and route structures.

### Step 5:

Server generates three-dimensional spatial information for visualization using the computed resource arrangement and movement path plan as input.

Server maps each resource, equipment unit, and path segment to nodes in a scene graph and assigns three-dimensional positions, orientations, and semantic tags to each node. Server composes this information with the terrain mesh to create visualization data, such as a scene file including geometry, materials, and camera parameters.

Output of Step 5 is visualization data suitable for rendering by the terminal.

### Step 6:

Terminal receives the visualization data as input from the server.

Terminal loads the scene file into a three-dimensional rendering engine, generates rendered frames according to a current camera position, and displays a three-dimensional view of the site to the user.

User inspects the layout, possibly selects objects or invokes menu commands, and the terminal transmits user interaction data back to the server.

Output of Step 6 is a displayed visualization and user interaction events.

### Step 7:

Server prepares a base prompt sentence using the internal planning data and visualization context as input.

Server reads key parameters such as site size, number of resources, and major constraints from the database, and the server creates a textual summary describing the current plan in natural language.

Server inserts specific numeric values and condition phrases into a template to form a coherently structured base prompt sentence that reflects the internal state.

Output of Step 7 is a base prompt sentence describing the current environment and plan.

### Step 8:

Server receives an optional user-specified prompt sentence from the terminal as additional input. User enters text such as “minimize crane movement while keeping evacuation routes clear,” and the terminal sends this text and a project identifier to the server.

Server combines the user-specified prompt sentence with the base prompt sentence by merging or appending phrases so that user intentions are incorporated without losing critical context. Output of Step 8 is a combined prompt sentence that integrates system-derived context and user intent.

### Step 9:

Server constructs an expanded prompt sentence and associated condition data using the combined prompt sentence and internal structured data as input.

Server retrieves numerical environment parameters, constraint values, and time-series work records, and converts them into controlled natural-language phrases appended to the combined prompt sentence.

Server simultaneously builds associated condition data by encoding three-dimensional spatial information as depth maps or coordinate arrays and encoding time-series work information as structured sequences.

Output of Step 9 is an expanded prompt sentence and a set of associated condition data ready to be input to a generative AI model.

### Step 10:

Server executes a generative AI model using the expanded prompt sentence and associated condition data as input.

Server tokenizes the expanded prompt sentence, feeds the tokens into a text encoder of the generative AI model, and feeds the condition data into conditioning channels of the model's network.

Server runs inference on dedicated hardware, performing iterative denoising or generative steps to produce image tensors or video frame sequences that visually represent site layouts or work flows.

Output of Step 10 is generated image information or generated video information stored in digital form.

### Step 11:

Server performs post-processing on the generated image information or video information as input.

Server resizes images or frames to target resolutions, overlays semantic markers such as icons for equipment or color-coded zones, and compresses the data for efficient transfer.

Server stores the processed results in persistent storage and registers metadata including the associated expanded prompt sentence and model parameters.

Output of Step 11 is post-processed image or video data with metadata entries.

### Step 12:

Terminal retrieves the post-processed image or video data from the server as input. Terminal downloads the media data and metadata, displays thumbnails or previews, and renders full-resolution images or videos when the user selects an item.

User reviews the generative AI results and may mark certain outputs as interesting candidates, and the terminal sends selection or rejection indications back to the server.

Output of Step 12 is user evaluation data associated with specific generated images or videos.

### Step 13:

Server analyzes the generated image information or video information as input in response to a user instruction.

Server applies feature extraction algorithms, such as semantic segmentation and object detection, to identify regions corresponding to resource arrangement regions, movement routes, and equipment placements.

Server maps identified regions back to three-dimensional coordinates using known camera parameters, and the server creates candidate updates to resource arrangement and movement path plan data.

Output of Step 13 is structured candidate planning data derived from the generative AI outputs.

### Step 14:

Server registers the structured candidate planning data as version-managed planning data using current plan data and candidate data as input.

Server assigns version identifiers, stores the candidate plan as an alternative in the planning database, and records links to the originating expanded prompt sentence and generated media.

Server updates an index or catalog of versions so that the terminal can query and present selectable alternatives to the user.

Output of Step 14 is a new version entry representing an alternative plan in the version-managed planning repository.

### Step 15:

Terminal receives a list of alternative plans and presents them to the user as input to a selection process.

User chooses to adopt, partially adopt, or reject one of the alternative plans through interaction controls on the terminal.

Terminal sends the user's selection command and the corresponding version identifier to the server.

Output of Step 15 is a selection command specifying which alternative plan is to be applied or discarded.

### Step 16:

Server updates the active resource arrangement and movement path plan using the selection command and version-managed planning data as input.

Server replaces or merges the current plan data with the selected alternative plan data according to predefined rules, and the server recalculates derived metrics such as total travel distance or safety margin indices.

Server generates updated visualization data from the revised plan and makes them available to the terminal for display.

Output of Step 16 is an updated active plan and corresponding visualization data.

### Step 17:

Terminal displays the updated visualization data as input for final review.

Terminal renders the revised three-dimensional layout and, optionally, side-by-side comparisons of previous and updated plans, and the user confirms whether the new configuration meets requirements.

User may initiate another iteration of prompt-based refinement or finalize the plan; the terminal transmits the corresponding instruction to the server.

Output of Step 17 is either a confirmation to proceed with further refinement or a finalization instruction for the current plan.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional computer-implemented systems for generating floor plans and interior design proposals typically operate in a one-way pipeline: a user inputs land information and design conditions, the system computes a limited set of layout options, and static three-dimensional visualizations or example interiors are rendered. These systems suffer from several technical shortcomings rooted in how computation and human feedback are handled.

First, known systems generally optimize layouts only with respect to explicitly provided constraint data (for example, legal limits, required rooms, basic spatial constraints) and simple scoring rules. The optimization logic does not adapt over time to the individual user based on how that user actually perceives and interacts with the generated layouts and images. As a result, the same or similar weighting of evaluation criteria is applied across users and across iterative sessions, which leads to repeated computations that do not converge efficiently toward user-specific solutions.

Second, existing systems do not effectively integrate multimodal behavioral signals-such as viewport manipulation patterns, viewing dwell times, facial expressions, and vocal reactions—into the computational loop. When these systems attempt to adjust design suggestions, they often rely on explicit user selection or manually entered preferences. This causes the processor to discard a large portion of implicitly available information about user satisfaction, increasing the number of iterations and network interactions needed to arrive at an acceptable proposal, and thereby increasing latency and computational load on both client and server.

Third, even when generative AI models are used to create interior images, conventional implementations typically rely on hand-crafted, static prompt sentences that do not systematically encode a user's latent preferences. The processor treats the prompt sentence as a fixed text input, and the generative AI model is repeatedly invoked with manually adjusted prompts. This technique results in redundant calls to the generative model, excessive GPU processing, and inconsistent outputs, because there is no stable, machine-learned representation of user preference feeding back into the prompt generation process.

Fourth, there is no integrated mechanism in conventional architectures to maintain and update a machine-readable preference parameter set that directly links user emotion and behavior to low-level layout features (for example, window area, ceiling height, storage amount, material type, color characteristics, furniture density) and to high-level prompt-sentence elements. Consequently, layout optimization and prompt-sentence generation run as loosely coupled or even entirely separate processes, which leads to duplicated computations, suboptimal resource utilization, and longer user-perceived response times.

Accordingly, there is a need for an improved computer-implemented system that (i) continuously acquires multimodal user feedback during interaction with three-dimensional models and interior images, (ii) transforms that feedback into structured preference parameters at the processor level using machine-learning models, and (iii) uses those parameters to dynamically reweight layout-evaluation functions and to automatically generate or correct prompt sentences supplied to a generative AI model. By tightly coupling behavior logging, emotion estimation, feature extraction, preference learning, and generative AI prompt construction within a single processing pipeline, the system can reduce the number of iterations, improve convergence toward user-specific layouts and interior images, and more efficiently utilize computing resources such as CPUs, GPUs, and memory.

The specific processing by the specific processing unit 290 of the data processing device 12 in Example 2 is realized by the following means.

The present invention provides a server comprising a processor configured to acquire land information and design condition information, to generate building layout proposals and corresponding three-dimensional model data based on the land information and the design condition information, to cause a client-side display device to present the three-dimensional model data and to receive operation history information including viewpoint operations and display durations of a user with respect to each presented building layout proposal, to acquire image information and audio information of the user from an imaging device and an audio acquisition device, to apply at least one machine learning model to the image information and the audio information to estimate an emotional state of the user with respect to each building layout proposal or an interior proposal derived therefrom, to extract, as feature quantities, attribute information of each proposal including at least opening area, ceiling height, storage amount, surface finish type, color characteristic, and furniture arrangement amount, to calculate preference parameters comprising weights for respective preference elements including brightness, wood texture feeling, storage amount, and openness based on the emotional state and the feature quantities, to update weight values of an evaluation function used for generating subsequent building layout proposals in accordance with the preference parameters, to generate or correct a generation instruction prompt sentence to be input to a generative artificial intelligence model based on the design condition information and the preference parameters, to input the prompt sentence together with condition information including at least one of the three-dimensional model data and a layout image into the generative artificial intelligence model to generate an interior image including at least furniture arrangement, color planning, and lighting planning, and to cause the interior image to be presented on the display device while further receiving additional operation history information and emotional state information related to the interior image and updating the preference parameters in response thereto. This enables an integrated, feedback-driven computation loop in which the processor continuously refines layout-generation scoring and generative-AI prompt sentences based on multimodal user interaction and emotion signals, thereby improving the efficiency, stability, and personalization performance of the computer system as a whole.

The term “land information” refers to digital data representing at least a size, a shape, and an orientation of a site on which a building is to be constructed, and may further include position data, elevation data, and surrounding environment data.

The term “design condition information” refers to digital data representing at least required facilities, regulatory conditions, and other planning conditions for a building, including, for example, legal height limits, floor-area ratio limits, required room types, and functional constraints.

The term “building layout proposal” refers to data representing a candidate arrangement of internal spaces of a building, including at least positions, dimensions, and uses of rooms and circulation paths within a building footprint.

The term “three-dimensional model data” refers to digital data describing geometric and structural information of a building or interior space in three-dimensional coordinates, including at least polygon meshes for floors, walls, ceilings, and openings, and being suitable for rendering by a three-dimensional graphics system.

The term “display device” refers to an electronic apparatus configured to visually present image data to a user, including, for example, a display panel of a portable terminal, a desktop monitor, or a head-mounted display.

The term “operation history information” refers to time-series data indicating user interaction with displayed content, including at least viewpoint operations such as zoom, rotation, and pan, content switching operations, and viewing durations associated with particular content items. The term “imaging device” refers to an electronic apparatus configured to acquire image information of a user, including, for example, a digital camera or an image sensor integrated into a terminal.

The term “audio acquisition device” refers to an electronic apparatus configured to acquire audio information of a user, including, for example, a microphone integrated into a terminal or connected externally.

The term “image information” refers to digital data representing visual information, including at least still images or video frames of a user's face or upper body acquired by an imaging device. The term “audio information” refers to digital data representing sound signals, including at least voice utterances of a user acquired by an audio acquisition device.

The term “machine learning model” refers to a computational model trained on example data to perform inference, including, for example, a neural network, a regression model, or a classification model executed by a processor.

The term “emotional state” refers to a representation of an affective condition of a user, expressed as one or more values or labels indicating at least feelings such as joy, dissatisfaction, surprise, confusion, or boredom, estimated from multimodal input data.

The term “interior proposal” refers to data describing a candidate configuration of an interior space based on a building layout proposal, including at least information about furniture arrangement, material finishes, color schemes, and lighting plans.

The term “attribute information” refers to structured data describing physical or visual properties of a building layout proposal or an interior proposal, including at least opening area, ceiling height, storage amount, surface finish type, color characteristic, and furniture arrangement amount.

The term “feature quantities” refers to numerical or categorical representations derived from attribute information and used as input variables to a machine learning model for estimating preferences or emotional responses.

The term “preference parameters” refers to numerical weights assigned to respective preference elements of a user, the preference elements including at least brightness, wood texture feeling, storage amount, and openness, and being calculated based on correlations between feature quantities and estimated emotional states.

The term “evaluation function” refers to a computational function that receives feature quantities of a building layout proposal as input and outputs an evaluation value by combining the feature quantities with corresponding weight values, thereby enabling comparison and optimization of multiple proposals.

The term “generation instruction prompt sentence” refers to a natural language text string that specifies content, style, and constraint conditions for generation of output data by a generative artificial intelligence model.

The term “generative artificial intelligence model” refers to a machine learning model configured to generate new digital content, including at least images, text, or three-dimensional data, based on input conditions such as text, images, or feature vectors.

The term “prompt sentence” refers to a generation instruction prompt sentence supplied to a generative artificial intelligence model as text input that conditions the content and style of generated output.

The term “condition information” refers to auxiliary data supplied to a generative artificial intelligence model together with a prompt sentence, including at least one of three-dimensional model data and a layout image, and used to condition the structure or appearance of generated output.

The term “interior image” refers to a two-dimensional digital image representing an interior space, including at least furniture arrangement, color planning, and lighting planning derived from a building layout proposal and associated parameters.

The term “interior finish material information” refers to data describing finishing materials applied to interior surfaces, including at least material type, color, and texture information for wall surfaces, floor surfaces, and ceiling surfaces.

The term “material information” refers to attribute data of a material, including at least a material category, optical characteristics, and basic rendering parameters used for assigning the material to a three-dimensional model.

The term “texture information” refers to data used to visually represent the surface appearance of a material, including at least image data, mapping parameters, and repetition parameters applied to surfaces of a three-dimensional model.

The term “word composition” refers to a structure and selection of lexical elements within a prompt sentence, including at least chosen words, phrases, and their ordering.

The term “style specification” refers to information contained in or associated with a prompt sentence that indicates a desired visual or aesthetic style of generated output, including, for example, indications of brightness, warmth, minimalism, or naturalness.

The term “constraint conditions” refers to explicit limitations or requirements included in or applied to a prompt sentence or generation instruction, including at least functional constraints, spatial constraints, and material constraints to be satisfied by generated content. The term “personalized prompt sentence” refers to a generation instruction prompt sentence whose word composition, style specification, and constraint conditions are adjusted based on preference parameters or recorded behavior of a specific user.

In an embodiment, a system is implemented as a networked architecture including a server, at least one terminal, and at least one user. The server is realized by a general-purpose computing device including at least one central processing unit (CPU), at least one graphics processing unit (GPU), a main memory, a non-volatile storage device, and a network interface.

The server executes a server operating system such as a server-class operating system, and on top of the operating system the server executes a web server component, an application server component, a relational database management system (RDBMS), and a machine-learning execution environment including a generative AI model execution environment.

The terminal is realized by a portable information processing device such as a tablet device, a smartphone, or a notebook computer, and includes a display device, a touch panel, an imaging device such as an integrated camera, an audio acquisition device such as an integrated microphone, a position information acquisition device such as a global navigation satellite system receiver, and a wireless or wired communication interface. The terminal executes a mobile operating system such as a handheld device operating system, and on top of the operating system the terminal executes a dedicated application implemented using a user-interface framework such as a mobile UI toolkit.

The user is a human operator, such as a designer or a customer, who operates the terminal to input land information and design condition information, to view three-dimensional model data and interior images, and to provide implicit feedback through facial expressions, vocal reactions, and interaction behaviors.

Server manages structured data related to land information, design condition information, layout proposals, materials, emotion logs, and preference parameters using the relational database management system. Server defines database tables such as a land information table, a design condition table, a layout table, a material table, an emotion log table, and a preference parameter table. Each table stores records with predefined schemas, for example: the land information table stores fields for area, shape type, orientation, latitude, and longitude; the design condition table stores fields for regulatory height limit, floor-area ratio, required room count, and presence of a workspace; the layout table stores identifiers of layout proposals, evaluation scores, and references to three-dimensional model files; the material table stores records for interior finishes including material category, color attributes, and texture file paths; the emotion log table stores timestamps, content identifiers, emotion scores, and behavior metrics; and the preference parameter table stores per-user weight vectors representing preference elements.

Server generates and stores program modules for land information acquisition, design condition acquisition, layout generation, three-dimensional model generation, material application, emotion estimation, feature extraction, preference estimation, evaluation-function updating, prompt sentence generation, and generative AI model invocation. Each program module is implemented in a general-purpose programming language and executes as a process or thread on the CPU, with specific machine-learning and generative-model computations assigned to the GPU. Terminal presents graphical user interfaces to the user for entering land information and design condition information. Terminal generates input controls such as numeric text fields, selection lists, toggle switches, and map views using the mobile UI framework. Terminal acquires touch events and key inputs, populates internal data structures representing land information and design conditions, and serializes these structures into a structured data format such as a JavaScript Object Notation document. Terminal establishes an encrypted communication channel, such as a secure hypertext transfer protocol session, to the server, and transmits the serialized land information and design condition information to an application programming interface provided by the server.

Server receives the structured data representing the land information and the design condition information, parses the structured data, and validates the data according to a predetermined schema. Server performs data-type checks and range checks and, if the data is valid, constructs database insertion commands using an object-relational mapping library. Server stores the land information record in the land information table and the design condition information record in the design condition table, associating them with a project identifier.

Server executes a layout generation program that reads land information and design condition information from the database and represents a building footprint region as a polygon in a two-dimensional coordinate system. Server initializes a population of building layout proposals, where each proposal is encoded as a data structure describing room entities with attributes including room type, position, width, depth, and adjacency relations. Server applies a genetic algorithm implemented using a genetic algorithm library to evolve the population. The genetic algorithm includes selection operators, crossover operators, and mutation operators. Server computes evaluation values for each proposal using an evaluation function that aggregates multiple criteria such as sunlight access, ventilation, compliance with spatial regulations, storage capacity, and workspace area. For complex criteria such as sunlight access, server applies a pre-trained regression or classification model implemented with a machine-learning library. This model can be, for example, a feedforward neural network that receives derived geometric features as input and outputs a predicted sunlight score. Server executes this model on the GPU to accelerate evaluation across the population.

Server iteratively applies the genetic algorithm until a termination condition is satisfied and then selects a subset of layout proposals having evaluation values above a threshold. Server converts each selected layout proposal into three-dimensional model data by extruding room polygons in the vertical direction, generating separate meshes for floors, walls, ceilings, and openings. Server uses a three-dimensional geometry library to construct polygon meshes and exports the meshes in a standard three-dimensional file format such as a scene description format. Server registers references to the generated three-dimensional model files in the layout table and sends identification information and uniform resource locators of the model files to the terminal. Terminal downloads the three-dimensional model files from the server over the network and loads them into a client-side three-dimensional rendering engine such as a graphics application programming interface or a game engine library. Terminal constructs scene graphs comprising nodes for geometries, materials, and lighting, configures a virtual camera, and renders views of the three-dimensional models on the display device. Terminal acquires gesture inputs from the user through touch events, interprets pinch gestures as zoom operations, drag gestures as rotation or panning operations, and swipe gestures as layout switching operations, and updates the camera parameters accordingly. Terminal re-renders the three-dimensional scenes based on the updated camera parameters. Terminal records operation history information including layout identifiers, time stamps for view start and end, counts of zoom operations, counts of rotation operations, and counts of layout switches, and stores the operation history information in local memory. Server maintains a predefined catalog of interior finish materials in the material table. Each material entry includes generic fields such as a material category (wall, floor, or ceiling), a base color in a color space, a texture image path, and basic physical parameters for shading. Terminal queries the catalog from the server and presents a list of interior finish materials to the user as thumbnail images and textual summaries. User selects desired wall materials and floor materials by tapping the thumbnails. Terminal collects identifiers of the selected materials and transmits them to the server.

Server receives the selected material identifiers, retrieves the corresponding material entries from the material table, and updates the three-dimensional model data by assigning material attributes and texture mappings to surfaces classified as walls, floors, or ceilings. Server re-exports updated three-dimensional model data and returns a reference to the updated data to the terminal. Terminal reloads or updates the three-dimensional scene graph with the new materials and re-renders the three-dimensional model so that the user can visually inspect the effect of the selected finishes.

Terminal activates the imaging device and the audio acquisition device while the user is viewing either three-dimensional models or interior images. Terminal acquires video frames from the camera at discrete time intervals and audio samples from the microphone in buffered segments. Terminal executes a face-detection algorithm, for example implemented by a convolution-based face-detection network accessed through a computer-vision library, to detect a face region in each frame. Terminal crops the face region, resizes it to a standard resolution such as 224 by 224 pixels, and normalizes pixel intensities. Terminal processes each audio segment using a signal-processing library to perform noise suppression and amplitude normalization, and optionally to compute simple acoustic descriptors.

Terminal associates each processed face image and each processed audio segment with metadata including the identifier of the currently displayed layout or interior image and a segment of the operation history information such as view start time, view end time, and interaction counts. Terminal packages this multimodal data in a structured format and transmits the data to the server using the secure communication channel.

Server receives the multimodal data and stores raw or referenced data entries in the emotion log table. Server executes an emotion estimation program implemented using a machine-learning library and executed on the GPU. Server applies a facial emotion recognition model comprising a convolutional neural network with multiple convolutional, pooling, and fully-connected layers.

This model receives a normalized face image as input and outputs a vector of emotion scores corresponding to categories such as joy, dissatisfaction, surprise, confusion, and boredom. The neural network is trained beforehand using supervised learning on labeled facial expression datasets, where server minimizes a cross-entropy loss function using stochastic gradient descent or a variant such as Adam, and updates network weights until convergence is achieved based on validation error.

Server applies a speech emotion recognition model to the processed audio segments. Server computes feature vectors such as mel-frequency cepstral coefficients, spectral statistics, and pitch-related parameters from the audio using a feature-extraction library. Server inputs these feature vectors to a recurrent neural network, such as a long short-term memory network or a gated recurrent unit network, or to a sequence transformer model. These models output emotion scores associated with emotional categories. These models are trained in advance using supervised learning, where server uses audio emotion datasets and minimizes a classification loss function, updating network weights via backpropagation.

Server fuses the emotion scores from the facial and speech models. For example, server can compute a weighted sum or apply a small fusion network that takes both sets of scores as inputs and outputs a final emotion score for each category. Server stores these emotion scores in the emotion log table together with the associated content identifiers and timestamps. Server also aggregates behavioral metrics from the operation history information, such as total viewing time for each layout or image, average zoom intensity, and frequency of abrupt switching, and stores them alongside emotion scores.

Server retrieves layout and interior proposal features from the layout table and associated metadata. Server represents attribute information for each proposal as a structured feature vector. The feature vector can include continuous values such as total window area, average ceiling height, total storage volume, average color brightness and saturation, and furniture density per unit area; and categorical values such as material category labels for walls and floors. Server applies encoding techniques such as one-hot encoding for categorical values, and normalization for continuous values. Server uses these feature vectors as explanatory variables and the derived emotion scores as target variables for a learning model.

Server executes a preference estimation program using a non-linear regression or classification algorithm such as gradient boosting or a random forest. In one embodiment, server applies a boosting-based decision-tree ensemble. For each training iteration, server splits data into training and validation sets, computes an objective function such as mean squared error or logistic loss, and updates model parameters to minimize the objective. Server computes feature importance metrics, such as gain-based or permutation-based importance, to determine how strongly each feature correlates with positive emotional responses. Server aggregates feature importance into preference parameters, which are weights for preference elements such as brightness, wood texture feeling, storage amount, and openness.

Server stores the preference parameters in the preference parameter table in association with the user or project. Server uses the preference parameters to adjust the evaluation function used in the layout generation program. For example, if the brightness preference weight is high, server increases the weight assigned to sunlight and window-area features in the evaluation function; if the storage preference weight is low, server decreases the weight assigned to storage features. Server then regenerates or refines layout proposals using the same genetic algorithm but with the updated evaluation function. Because the evaluation function is adapted based on learned preferences, the search space is more efficiently explored in directions that are more likely to satisfy the user's latent preferences, thereby reducing the number of generations and evaluation computations required to produce satisfactory proposals.

Server also employs the preference parameters to generate or correct a prompt sentence to be input to a generative AI model. Server constructs a base prompt sentence from design condition information such as number of rooms, presence of a home office, and orientation of main rooms. Server then modifies or augments the base prompt sentence with phrases derived from the preference parameters. Server may use a template mechanism in which specific preference attributes map to predefined linguistic phrases, or a small language model that composes natural language according to encoded preference vectors. For example, when the brightness preference parameter is high and a wood texture preference is present, server constructs a prompt sentence such as:
“Please generate an interior image for a south-facing living room in a 3LDK apartment. The client strongly prefers brightness and natural wood textures. Use large south-facing windows, light oak flooring, and white walls to maximize sunlight. Apply a natural modern style with simple furniture and several green plants.”

Server may generate other examples of prompt sentences, such as:
“Please generate an interior image for a home office that matches a 3LDK layout. The client prefers bright colors and a warm wooden atmosphere. Use pastel-colored chairs, a wooden desk, and a layout that supports high work efficiency.”

“Please propose an interior design for a south-facing living room that maximizes sunlight. Use bright wood flooring and white walls in a natural modern style, and place large potted plants and a simple sofa.”

By encoding user-specific preference parameters in this manner, server reduces the need for manual trial-and-error editing of prompt sentences and stabilizes the input to the generative AI model.

Server executes a generative AI model, such as a text-to-image diffusion model, within the machine-learning execution environment. Server encodes the generated prompt sentence using a text encoder, such as a transformer-based encoder, to obtain a text embedding. Server optionally encodes a layout image or floor-plan image generated from the three-dimensional model data, using an image encoder or a conditional module such as a control network. Server initializes a noise vector or latent representation and iteratively applies denoising steps according to a diffusion schedule implemented in a diffusion-model library. At each denoising step, server combines the current latent state with gradients derived from the text and image conditions, so that the latent representation gradually becomes consistent with the prompt sentence and any structural constraints. Server decodes the final latent representation into an interior image with specified resolution. Server stores the resulting image in a storage device and records its association with the layout identifier and prompt sentence in the database.

Terminal retrieves identifiers or uniform resource locators of the generated interior images from the server and downloads the images as needed. Terminal presents the images in a gallery interface and allows the user to swipe through images, zoom into details, and select preferred proposals. While the user is viewing generated interior images, terminal continues to capture face images and audio segments, build operation history information, and transmit them to the server. Server repeats emotion estimation and preference updating processes. Because the preference parameters influence both layout generation and prompt sentence generation, the computational pipeline converges more quickly toward images and layouts that match user preferences, thus reducing the total number of iterations of the generative model and saving GPU processing time. This configuration yields multiple technical effects. Because server encodes user preferences as numeric parameters updated by supervised learning on multimodal signals, server reduces repeated processing of unpromising layout regions and concentrates computational resources on preferred design regions, improving processing speed and reducing resource usage compared to systems that lack such adaptive weighting. Because terminal performs pre-processing of face images and audio segments locally, including cropping, resizing, and noise reduction, the volume of data transmitted to the server is reduced, thus reducing communication load. Because server structures behavioral and emotion data into time-series logs and feature vectors, and processes them using machine-learning algorithms with specific architectures, the system achieves more accurate preference estimation and reduces misalignment between generated proposals and actual user preferences, thereby reducing the number of times that resource-intensive generative AI model invocations are required.

Server does not merely automate manual design work but implements a novel computational interaction loop in which machine-learning-based emotion estimation and preference modeling control technical parameters of layout optimization algorithms and generative AI prompt construction. For example, by adjusting genetic-algorithm weights and diffusion-model conditioning according to preference parameters derived from neural-network outputs, server controls the search direction in a high-dimensional design space using optimization techniques and embedding-space navigation that are not available to human operators performing manually. This non-traditional processing path yields more efficient convergence and lower error rates in matching generated content to latent user preferences.

In alternative embodiments, server may employ different neural-network architectures, such as residual networks for facial emotion recognition, convolutional-recurrent hybrids for audio processing, or variational autoencoders for feature embedding. Server may adopt alternative optimization algorithms such as simulated annealing or particle swarm optimization in place of a genetic algorithm, so long as server uses preference parameters to adjust evaluation-objective weights for layout proposals. Server may also integrate other types of behavioral data, such as eye-tracking data captured by specialized sensors, into emotion and preference modeling. Terminal may be a head-mounted display or an augmented-reality device capable of overlaying generated interior images onto a real-world environment.

By employing the described data structures, processing modules, and learning-based feedback loop, the system improves computer technology itself by increasing computational efficiency, reducing network bandwidth requirements, and achieving higher accuracy in the alignment between generated design outputs and user preferences, in a manner that cannot be realized by simple automation of conventional human design processes.

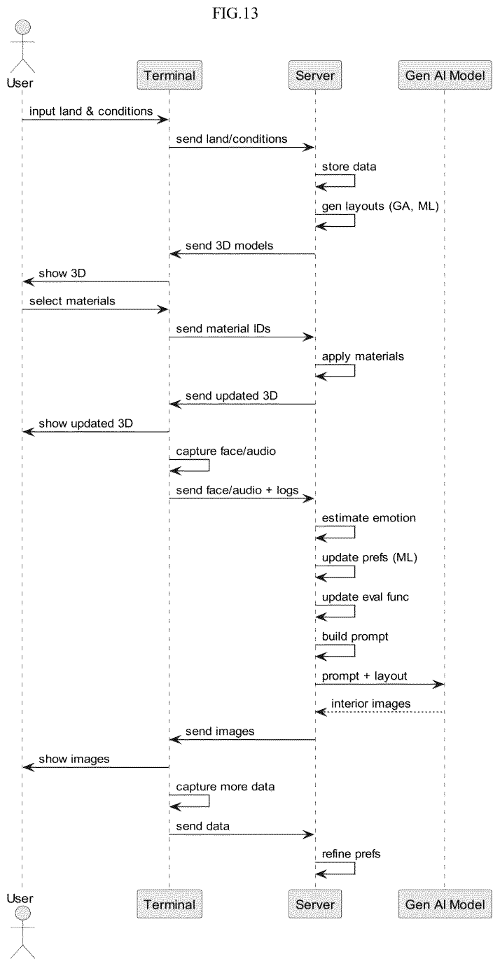

The following describes the processing flow using FIG. 13.

### Step 1:

Terminal displays land-information and design-condition input screens using a mobile UI framework.

Terminal receives, as input, raw user interactions on input widgets such as numeric fields for site area, lists for site shape and orientation, and selectors for regulatory limits and required rooms. User touches the screen to enter values such as site area, site shape, orientation, height limit, floor-area ratio, number of rooms, and presence of a home office.

Terminal converts the widget states into an internal data structure representing land information and design condition information, and serializes this structure into a structured text format. Terminal outputs structured land information and design condition information and sends them via an encrypted communication channel to the server.

### Step 2:

Server receives the structured land information and design condition information from the terminal through an application programming interface.

Server takes, as input, the serialized data and parses it into in-memory objects using a data-parsing library.

Server performs data validation by checking required fields, data types, and numeric ranges; server rejects invalid records and returns error messages, or proceeds when validation passes. Server executes database insertion operations using an object-relational mapping component, thereby writing validated land information and design condition information into corresponding database tables.

Server outputs persistent records stored with project identifiers and makes them available for subsequent processing.

### Step 3:

Server initiates a layout generation program after storing the land information and design condition information.

Server reads, as input, land information (site area, shape, orientation) and design condition information (height limit, floor-area ratio, room requirements) from the database. Server computes a building footprint polygon inside the site boundary by performing geometric calculations that respect shape and regulatory constraints.

Server generates an initial population of building layout proposals, each proposal represented as a structured data object containing room types, positions, dimensions, and adjacency links. Server outputs an initial population of layout proposals ready for evaluation and evolution.

### Step 4:

Server applies a genetic algorithm to evolve the population of layout proposals.

Server takes, as input, the current population of layout proposals with their geometric and semantic attributes.

Server computes evaluation values for each proposal using an evaluation function that aggregates criteria such as sunlight access, ventilation, regulatory compliance, storage capacity, and workspace adequacy; for complex criteria, server calls pre-trained prediction models executed on a GPU.

Server performs selection, crossover, and mutation operations: server selects high-scoring proposals, recombines room arrangements between selected parents, and perturbs room positions or sizes according to mutation rules.

Server outputs an updated population of layout proposals with new evaluation values and repeats this evolution until a termination condition is met.

### Step 5:

Server selects final layout proposals and converts them into three-dimensional model data. Server takes, as input, the evolved population with evaluation scores and chooses proposals whose evaluation values exceed a threshold or belong to top-ranked candidates.

Server constructs three-dimensional meshes by extruding room polygons into volumes, generating floor meshes, wall meshes, ceiling meshes, and opening meshes; server uses a three-dimensional geometry library to calculate vertex positions and face indices.

Server exports the three-dimensional model data into a standard format and records file locations and layout identifiers in the database.

Server outputs layout identifiers and model references and transmits them to the terminal.

### Step 6:

Terminal receives layout identifiers and three-dimensional model references from the server and retrieves the corresponding model files.

Terminal takes, as input, the identifiers and file locations and initiates network downloads to obtain the model data.

Terminal loads the three-dimensional models into a client-side rendering engine, constructs a scene graph, sets up a virtual camera, and renders images on the display.

Terminal captures user input events such as pinch gestures, drag gestures, and swipe gestures, and converts these into camera transformations that change zoom level, rotation, and viewpoint.

Terminal outputs rendered views of the three-dimensional layouts and simultaneously logs operation history information including timestamps, layout identifiers, and counts of interaction operations.

### Step 7:

Terminal presents interior finish material options retrieved from the server and collects user selections.

Terminal takes, as input, material catalog data including material categories, color attributes, and texture references.

Terminal displays a list or grid of material options with thumbnails and text descriptions, enabling the user to select wall and floor finishes by tapping.

User selects desired materials, and the terminal records the selected material identifiers.

Terminal outputs the selected material identifiers and sends them to the server for application to the three-dimensional models.

### Step 8:

Server receives material selections and applies them to the three-dimensional model data. Server takes, as input, layout identifiers and selected material identifiers from the terminal. Server queries the database for corresponding material records, reads texture file paths and shading parameters, and assigns the materials to wall, floor, or ceiling surfaces in the three-dimensional model.

Server recalculates texture coordinates, scaling factors, and repetition settings for each surface, and updates the three-dimensional model data accordingly.

Server outputs updated three-dimensional model data and returns references to the terminal so that the updated interior finishes can be rendered.

### Step 9:

Terminal renders updated three-dimensional model data with assigned materials and displays them to the user.

Terminal takes, as input, the updated model files or material override information from the server.

Terminal updates the scene graph with new material properties and re-renders the three-dimensional scene, showing the chosen wall and floor finishes.

Terminal continues to track interaction events such as more detailed zooming into surfaces or switching between material configurations.

Terminal outputs updated visualizations and additional operation history information reflecting the user's reactions to material changes.

### Step 10:

Terminal captures facial images and audio segments while the user views three-dimensional layouts or interior images.

Terminal takes, as input, raw video frames from the imaging device and raw audio samples from the audio acquisition device.

Terminal executes a face-detection algorithm that locates and crops face regions, then resizes and normalizes face images; terminal processes audio by applying noise reduction and amplitude normalization.

Terminal associates each processed image and audio segment with the current content identifier (layout or image) and the corresponding segment of operation history information. Terminal outputs multimodal observation data packets containing face images, audio segments, content identifiers, and behavior metrics, and transmits them to the server.

### Step 11:

Server estimates emotional states of the user from the multimodal observation data. Server takes, as input, face images, audio segments, content identifiers, and operation history information from the terminal.

Server applies a facial emotion recognition neural network to each face image to compute emotion scores for categories such as joy, dissatisfaction, surprise, and boredom; server applies a speech emotion recognition neural network to acoustic feature vectors extracted from audio segments to compute voice-based emotion scores.

Server fuses the face-based and voice-based scores, for example by weighted averaging or by inputting them into a small fusion network, to obtain a combined emotional state vector for each observation period.

Server outputs emotion records that link emotional state vectors to specific layouts or interior images and stores these records in the emotion log table.

### Step 12:

Server extracts feature quantities from layout and interior proposals and estimates preference parameters.

Server takes, as input, emotion records and proposal feature data from layout and interior tables. Server constructs feature vectors for each proposal, including numeric values such as window area, ceiling height, storage amount, color brightness and saturation, and furniture density, and encoded categorical values such as material types.

Server uses a machine-learning model, such as a gradient boosting ensemble, to learn a mapping from feature vectors to positive emotion scores, computes feature importance values, and aggregates these into preference parameters representing weights for brightness, wood texture feeling, storage amount, openness, and other preference elements.

Server outputs updated preference parameter vectors and stores them in the preference parameter table for use in subsequent computations.

### Step 13:

Server updates the evaluation function used for layout generation based on the estimated preference parameters.

Server takes, as input, the current preference parameter vector and the definition of the layout evaluation function.

Server modifies the internal weight values associated with evaluation criteria; for example, server increases the weight for sunlight-related features when brightness preference is high, and decreases the weight for storage-related features when storage preference is low.

Server recalculates composite evaluation scores for candidate or newly generated layouts using the updated evaluation function, thereby shifting selection pressure toward proposals that align with user preferences.

Server outputs adjusted evaluation logic and, optionally, new or refined layout proposals based on the reweighted search.

### Step 14:

Server generates or corrects a prompt sentence for a generative AI model using the design condition information and preference parameters.

Server takes, as input, design condition records (such as room count and home office requirement), material selections, and the preference parameter vector.

Server constructs a base natural language description of the space, then inserts or modifies phrases indicating style and preference elements, such as “maximize sunlight,” “bright colors,” or “natural wood textures,” according to the weights in the preference parameters.

Server outputs a complete prompt sentence, such as “Please generate an interior image for a south-facing living room in a 3LDK apartment. The client strongly prefers brightness and natural wood textures. Use large south-facing windows, light oak flooring, and white walls to maximize sunlight. Apply a natural modern style with simple furniture and several green plants.” Step 15:

Server invokes the generative AI model to produce interior images conditioned on the prompt sentence and structural information.

Server takes, as input, the generated prompt sentence and condition information such as three-dimensional model data or layout images.

Server encodes the prompt sentence using a text encoder to produce a text embedding, optionally encodes a layout image using an image encoder, and initializes a latent representation; server then iteratively applies a diffusion or generative process that refines the latent representation under guidance from the embeddings.

Server decodes the final latent representation into a high-resolution interior image that reflects both the layout structure and the stylistic constraints specified in the prompt sentence. Server outputs the generated interior image, stores it with an associated layout identifier and prompt text in the database, and sends an image reference to the terminal.

### Step 16:

Terminal retrieves and displays generated interior images and continues collecting interaction and emotion data.

Terminal takes, as input, references or identifiers for generated interior images from the server.

Terminal downloads the corresponding image files, displays them in a gallery or full-screen view, and allows the user to swipe, zoom, and select preferred images.

Terminal logs viewing durations and interaction events for each interior image and continues to acquire face images and audio segments during viewing, processing and packaging them as in earlier steps.

Terminal outputs updated multimodal observation data and selection information to the server, enabling server to refine preference parameters further and, if needed, regenerate layouts and interior images more closely aligned with user preferences.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional computer-implemented planning systems that generate spatial layouts or work plans in a three-dimensional environment typically optimize only objective, machine-centric criteria such as travel distance, collision avoidance, or resource utilization. These systems generally treat the user interface as a static output channel and do not adapt either the optimization logic or the presentation logic based on how users actually perceive and understand the generated plans. As a result, although the underlying optimization may be mathematically sound, users frequently experience confusion, anxiety, or irritation when interpreting complex layouts and procedures rendered on a display device. This mismatch between the internal computational model and human cognitive constraints leads to increased training costs, frequent rework of plans, and a higher risk that critical safety-related information is overlooked in practice.

In parallel, conventional systems that utilize generative artificial intelligence models to produce visual simulations or explanatory images generally rely on fixed or manually authored prompt sentences. These prompt sentences are usually crafted by engineers or designers at design time and are not dynamically adapted at runtime to reflect specific spatial conditions, current planning states, or user emotion states. Consequently, the generative outputs, even when visually impressive, may emphasize irrelevant aspects, omit key hazards or routes, or present information at an inappropriate level of detail. This lack of adaptive control over the prompt sentences leads to suboptimal use of generative AI capabilities and fails to fully support users in accurately and efficiently understanding the underlying three-dimensional plans.

Furthermore, known emotion estimation techniques in human-computer interaction are often used only for coarse personalization or simple content recommendations, and are not integrated into the core computational pipeline of layout optimization and simulation generation. Existing systems typically do not feed back emotion-related data, such as confusion or irritation observed during interaction with simulations, into the optimization objective functions, constraint sets, or prompt generation policies. As a result, the computer system does not improve, over time, its ability to generate layouts and visual explanations that minimize psychological load while maintaining physical efficiency.

Therefore, there is a need for an improved computer-implemented system that: (i) structurally integrates emotion-related sensing and estimation into the processing pipeline for generating three-dimensional layout plans; (ii) uses psychological load indices as first-class optimization criteria in mathematical layout generation; and (iii) dynamically controls prompt sentences for a generative AI model in accordance with site conditions, planning information, and user emotion states. Such a system should adapt both the computational behavior and the user interface behavior to reduce user confusion, anxiety, and irritation, thereby improving the technical performance of the planning and simulation system as a whole in terms of usability, safety support, and robustness of understanding.

The specific processing by the specific processing unit 290 of the data processing device 12 in Application Example 2 is realized by the following means.

The present invention provides a server comprising a processor configured as an environmental information input unit, a planning information setting unit, a three-dimensional model generation unit, a layout plan generation unit, an emotion-related information acquisition unit, an emotion state estimation unit, a user interface control unit, a prompt sentence generation unit for a generative AI model, and a simulation presentation unit. This enables the server to acquire terrain information and surrounding environment information of a physical space, to generate three-dimensional model data of the physical space, to generate a layout plan including placement positions and movement routes of resources in the physical space by mathematical optimization or search processing while incorporating a psychological load index as an evaluation function or constraint condition, to acquire facial expression information, voice information, and operation information from a terminal device and convert them into emotion estimation feature quantities, to estimate an emotion state including at least confusion, anxiety, or irritation using a machine learning model and to hold the emotion state as an internal state, to dynamically control a presentation mode of the layout plan and planning information by changing a layout of a display screen, a detail level of display information, a highlight region, and an amount or expression level of explanatory text in accordance with the emotion state, to automatically generate a prompt sentence describing generation conditions for the generative AI model based on the three-dimensional model data, the layout plan, the planning information, and the emotion state by selecting, from among a plurality of templates having attributes such as safety emphasis, efficiency emphasis, and ease-of-understanding emphasis, a template corresponding to the emotion state and embedding conditions of the physical space, key points of the layout plan, and schedule information into the selected template, and to obtain image data or video data generated by the generative AI model to which the prompt sentence is input and present the image data or the video data to the terminal device in combination with an interactive display based on the three-dimensional model data, thereby improving operation of the computer system by adaptively reducing user psychological load, enhancing user comprehension of complex three-dimensional plans, and increasing the effectiveness and technical utility of generative AI-based simulations.

The term “environmental information input unit” refers to a functional component implemented by a processor and associated circuitry or software, which acquires location information, shape information, and surrounding situation information relating to a physical space, and converts such information into terrain information and surrounding environment information used for generating a three-dimensional model.

The term “planning information setting unit” refers to a functional component implemented by a processor and associated circuitry or software, which receives input of schedule information, resource information, and safety condition information relating to work to be executed in a physical space, structures the input, and stores the structured information as planning information.

The term “three-dimensional model generation unit” refers to a functional component implemented by a processor and associated circuitry or software, which generates three-dimensional model data representing a physical space based on terrain information and surrounding environment information, for example by performing point cloud processing, meshing, and coordinate transformation.

The term “layout plan generation unit” refers to a functional component implemented by a processor and associated circuitry or software, which automatically generates a layout plan including placement positions and movement routes of resources in a physical space by executing mathematical optimization processing or search processing on three-dimensional model data and planning information.

The term “layout plan” refers to data representing at least placement positions of resources and movement routes of resources or workers within a physical space, expressed in a coordinate system of three-dimensional model data and used for planning or executing work.

The term “psychological load index” refers to a numerical value or set of numerical values representing an estimated level of psychological burden on a user, such as confusion, anxiety, or irritation, calculated based on emotion-related data, historical interaction data, or learned models, and used as an evaluation quantity or constraint in optimization of a layout plan. The term “emotion-related information acquisition unit” refers to a functional component implemented by a processor and associated circuitry or software, which acquires facial expression information, voice information, and operation information from a terminal device including at least a display device, an imaging device, a voice acquisition device, and an operation history acquisition device, and generates emotion estimation feature quantities through preprocessing of the acquired information.

The term “emotion estimation feature quantities” refers to numerical feature vectors or structured data derived from raw facial images, audio signals, and user operation logs, which are suitable as input to a machine learning model configured to estimate an emotion state.

The term “emotion state estimation unit” refers to a functional component implemented by a processor and associated circuitry or software, which uses a machine learning model or statistical model to estimate, from emotion estimation feature quantities, an emotion state that includes at least one of reassurance, confusion, anxiety, and irritation, and an intensity of the emotion state, and which maintains the estimated emotion state as an internal state.

The term “emotion state” refers to internal data representing a psychological condition of a user, encoded as one or more predefined emotion categories, such as reassurance, confusion, anxiety, irritation, concentration, or fatigue, and an associated intensity or probability for each category.

The term “user interface control unit” refers to a functional component implemented by a processor and associated circuitry or software, which dynamically modifies at least one of a screen layout, a level of detail of display information, a highlighted region, and an amount or expression level of explanatory text, in accordance with an emotion state, and thereby controls how a layout plan and planning information are presented to a user.

The term “prompt sentence generation unit for the generative AI model” refers to a functional component implemented by a processor and associated circuitry or software, which automatically generates a text prompt sentence describing generation conditions to be input to a generative AI model, based on three-dimensional model data, a layout plan, planning information, and an emotion state.

The term “prompt sentence” refers to text data, expressed in a natural language or a similar symbolic format, that specifies requested contents, constraints, or emphasis criteria for content generation by a generative AI model, including at least one of spatial conditions, layout key points, work procedures, or safety-related notes.

The term “template” refers to a predefined text pattern including placeholders, which can be filled with context-specific information such as physical space conditions, layout plan summaries, or schedule information, to form a prompt sentence having a desired emphasis attribute.

The term “safety emphasis” refers to an attribute of a template or a prompt sentence that causes a generative AI model or a user interface to prioritize representation of hazardous regions, evacuation routes, safety distances, and safety precautions in generated content. The term “efficiency emphasis” refers to an attribute of a template or a prompt sentence that causes a generative AI model or a user interface to prioritize representation of travel distances, resource utilization, or time-saving aspects in generated content.

The term “ease-of-understanding emphasis” refers to an attribute of a template or a prompt sentence that causes a generative AI model or a user interface to prioritize clarity, step-by-step explanation, simplified graphics, or reduced clutter to facilitate user comprehension. The term “generative AI model” refers to a machine learning model that generates new content data, such as image data or video data, in response to an input prompt sentence, the model being implemented by at least one neural network trained to map textual conditions to visual outputs.

The term “simulation presentation unit” refers to a functional component implemented by a processor and associated circuitry or software, which obtains image data or video data generated by a generative AI model based on a prompt sentence, and presents the obtained data to a terminal device, in combination with an interactive display based on three-dimensional model data.

The term “terminal device” refers to an information processing device operated by a user, including at least a display device, an input device, an imaging device, a voice acquisition device, and a communication interface, and configured to transmit and receive data to and from a server device and to present a user interface.

The term “server device” refers to a computing device or a group of computing devices including at least one processor, memory, storage, and a communication interface, configured to execute programs that implement the environmental information input unit, the planning information setting unit, the three-dimensional model generation unit, the layout plan generation unit, the emotion-related information acquisition unit, the emotion state estimation unit, the user interface control unit, the prompt sentence generation unit, and the simulation presentation unit.

The term “three-dimensional model data” refers to data structures that represent a physical space in a three-dimensional coordinate system, including at least one of terrain meshes, building volumes, road geometries, and resource objects, and that are used for visualization, analysis, or layout optimization.

The term “resource” refers to an entity used or moved in a planned work environment, including at least materials, machines, equipment, or workers, for which placement positions or movement routes are planned in a layout plan.

The term “movement route” refers to a path or sequence of positions in a physical or virtual coordinate space, along which a resource such as a machine or a worker is expected to move according to a layout plan or work plan.

The term “evaluation function” refers to a mathematical function that assigns a numerical score or cost to a candidate layout plan based on one or more criteria, such as travel distance, resource usage, or predicted psychological load, and that is used as an objective in optimization.

The term “constraint condition” refers to a mathematical condition or logical rule that restricts allowable solutions in generation of a layout plan, such as collision avoidance, minimum safety distance, time constraints, or bounds on psychological load indices.

The term “psychological load index model” refers to a machine learning model trained to output predicted values of psychological load indices, such as confusion, anxiety, or irritation, based on features derived from layout characteristics, simulation content, or interaction data.

In one embodiment, a server, a terminal, and a user cooperate to implement the claimed system. The server includes at least one processor, a main memory, a non-volatile storage device, and a network interface. The server operates on a general-purpose server operating system, such as a UNIX-like operating system, and executes application software including a web application framework, a database management system, a numerical computation library, and a deep learning framework. The terminal includes at least a mobile processor, a display, an imaging device, a voice acquisition device, an input device, a local storage, and a wireless communication interface, and operates on a mobile operating system using either a web browser or a dedicated application.

The server executes programs that implement an environmental information input unit, a planning information setting unit, a three-dimensional model generation unit, a layout plan generation unit, an emotion-related information acquisition unit, an emotion state estimation unit, a user interface control unit, a prompt sentence generation unit for a generative AI model, and a simulation presentation unit. Each unit is realized as a software module or microservice running on the processor and interacting through defined data structures stored in the database and memory.

The server uses the environmental information input unit to acquire terrain information and surrounding environment information for a physical space, such as a construction site, a factory floor, or a warehouse. The server receives point cloud files from external measurement devices, such as laser range finders mounted on unmanned vehicles or aerial vehicles, via the network interface. The server uses a three-dimensional point cloud library (for example, a point cloud processing library that implements voxel grid downsampling, statistical outlier removal, and surface reconstruction) to load the point cloud into memory as a set of floating-point vectors representing three-dimensional coordinates. The server applies numerical processing including statistical filtering and coordinate normalization to generate a regularized cloud. The server then executes a meshing algorithm, such as Poisson surface reconstruction or Delaunay triangulation, to form a triangle mesh representing the topography.

The server obtains surrounding environment information, such as building footprints and roads, by sending structured queries to an external map service over HTTP and receiving geospatial data, for example in a JSON-based geographic data format. The server applies matrix operations to transform external coordinates into a local coordinate frame of the site, and stores the transformed polygons and polylines in the database as records associated with the project identifier. The server thus forms three-dimensional model data combining a terrain mesh, volumetric approximations of surrounding structures, and spatial references for later placement of resources.

The terminal receives a downsampled version of the three-dimensional model data from the server and uses a three-dimensional rendering library, such as a graphics API exposed through a web engine or a game engine, to render the geometry. The terminal maintains an internal scene graph including nodes for terrain, buildings, and future resource objects. The user interacts with the terminal by performing touch gestures on the display. When the user taps a point that is intended to serve as a candidate yard or restricted area, the terminal performs ray casting using the rendering library's camera and projection parameters to convert screen coordinates into a three-dimensional intersection point with the terrain mesh. The terminal sends the resulting coordinates and metadata to the server, which stores them in a candidate location data structure.

The planning information setting unit running on the server receives, from the terminal, planning information that includes stages, required material types and quantities, machine types and counts, and worker requirements. The server stores this planning information in normalized database tables. The server uses a rule engine module to evaluate constraints such as time-of-day restrictions and minimum safety distances, by applying declarative rules to the planning records.

The server generates violation messages when rules are not satisfied and sends these messages to the terminal. The terminal displays these messages on the display to prompt the user to adjust the input. In this way, the server enforces technical and safety constraints before optimization of any layout plan.

The server uses the three-dimensional model generation unit and the planning information setting unit to construct inputs for the layout plan generation unit. The layout plan generation unit formulates a mathematical optimization problem that includes decision variables representing placement positions for material groups, route selection for movement of machines and workers, and assignment of material groups to candidate yard locations. The server defines an objective function that aggregates physical metrics such as total travel distance, expected handling cost, and collision penalty, and also includes a psychological load index term. The server uses a numerical optimization solver, such as a linear or mixed-integer programming solver implemented by a numerical library, to minimize this combined objective subject to constraints. The server uses a psychological load index model to calculate predicted confusion, anxiety, or irritation for candidate layouts. The server constructs feature vectors from candidate layout configurations, such as the number of direction changes on main routes, the number of occluding objects within a certain radius of a path, and the distance from high-risk zones to evacuation routes. These features are passed to a neural network implemented in a deep learning framework. The neural network, for example, may be a feed-forward network including several fully connected layers with rectified linear unit activations, trained using mini-batch gradient descent and an error function such as mean squared error between predicted and observed psychological ratings. During inference, the server computes predicted psychological scores, and incorporates these scores into the objective function as penalty terms. By embedding this calculation inside the optimization loop, the server produces layouts that are simultaneously efficient and psychologically easier to understand.

The server uses the emotion-related information acquisition unit and the emotion state estimation unit to obtain real-time emotion states. The terminal captures frames from the imaging device and extracts facial landmarks using a computer vision library, such as a face detection and landmark extraction module. The terminal converts landmark positions into numerical features such as normalized distances and angles between key points. The terminal samples audio through the voice acquisition device and computes spectral features, such as mel-frequency cepstral coefficients, using an audio analysis library. The terminal also monitors its own user interface event logs and derives features such as frequency of error messages and the duration for which certain dialogs remain open. The terminal compresses these features and transmits them to the server.

The server receives the feature vectors and feeds them into a multimodal deep neural network. In one implementation, the server uses separate subnetworks for different modalities: a convolutional subnetwork for facial features, a recurrent subnetwork for audio features to capture temporal dependencies, and a dense subnetwork for interaction features. The server concatenates intermediate representations from these subnetworks and passes them through additional dense layers to output logits for emotion categories. During training, the server uses labeled data with annotations of user emotions, and applies a cross-entropy loss function to train network weights by backpropagation using an optimizer such as Adam. The server stores the trained network parameters in the storage device and loads them into memory for inference.

The server executes this model during system operation to obtain probabilities for emotion categories such as reassurance, confusion, anxiety, and irritation. The server selects the category with the highest probability as the dominant emotion and stores the category and probability as an emotion state record in the database. The server sends the current emotion state to the terminal. Because the emotion state is periodically updated, the server and the terminal can react to dynamic changes in the user's psychological condition. This leads to a technical effect: the user interface and the optimization logic are adapted automatically in terms of information density and focus, reducing user cognitive load and interaction errors without requiring additional manual input.

The terminal uses the user interface control unit to adjust its display behavior based on received emotion states. The terminal changes layout parameters of its own user interface, such as font size, color emphasis, and visibility of advanced options. In a safety-focused mode triggered by an anxious emotion state, the terminal overlays high-risk zones and evacuation routes in strong colors using shader parameters in the graphics pipeline, and shows expanded safety messages in a side panel. In a simplified mode triggered by confusion, the terminal hides secondary controls and compresses tables into summary cards, thus reducing the number of onscreen items and, consequently, the number of render operations and user interactions. This adaptation improves computational efficiency at the terminal side by selectively reducing rendering of non-essential elements and avoids re-render cycles caused by unnecessary interactions.

The server uses the prompt sentence generation unit for the generative AI model to construct prompt sentences that are tailored to the current three-dimensional model data, layout plan, planning information, and emotion state. The server stores multiple text templates that include placeholders for site type, key layout characteristics, main stage descriptions, and safety or efficiency emphasis. Each template is tagged with one or more attributes, such as safety emphasis, efficiency emphasis, or ease-of-understanding emphasis. The server selects a suitable template by evaluating the emotion state and the user's intention communicated from the terminal, such as a selection between “safety,” “efficiency,” or “explanation.” The server fills the placeholders with dynamically generated text derived from the current database state. For example, the server inserts phrases describing positions of major material groups, typical machine paths, and location-based hazards. The server thus produces a complete prompt sentence. In one example, when the emotion state indicates anxiety and the user requests a safety-focused simulation, the server generates a prompt sentence of the following form:

“Based on the current material layout plan at a narrow urban construction site, generate one clear and informative image that explains the safe walking routes for workers during the foundation work stage. Highlight all hazardous zones, such as crane swing areas and truck routes, in red, and mark safe walking paths and emergency exits in green with simple labels. Place large material stacks near the lifting equipment and small tools close to the worker positions. Avoid excessive visual clutter so that first-time workers can understand the safe movement patterns at a glance.” In another example, when the emotion state indicates irritation but confusion is low and the user emphasizes efficiency, the server generates a concise prompt sentence, such as:

“For the current material layout plan of a compact construction site, generate two bird's-eye-view images that prioritize minimizing travel distance of heavy machinery. Show only the positions of material yards and the movement arrows of machines in a simple and clear manner, without detailed text annotations.”

In a further example, when the emotion state indicates lack of understanding, the server generates an explanation-focused prompt sentence, such as:

“Using the current material layout plan and stage schedule, generate an animated video that shows the main work procedures from foundation work to structural erection in a step-by-step manner. In each step, illustrate which materials are used, where they are stored, and how each machine and each worker moves, using arrows and labels. Emphasize safe walking paths and emergency evacuation routes so that new workers can easily understand the workflow.”

The server sends the generated prompt sentence to the generative AI model, which may be hosted on the same server or on a separate machine accessible through an application programming interface. In one implementation, the server uses a diffusion-based generative model that accepts the prompt sentence and generates images by iteratively denoising a latent representation. The server encodes the prompt sentence using a text encoder network and uses this encoded representation to guide the diffusion steps according to the generative AI model's architecture. The server uses the deep learning framework to perform tensor operations and sampling steps using a graphics processing unit, thereby improving inference speed and allowing near real-time generation of complex simulations.

The server receives output from the generative AI model, such as image data in a raster format or video data in a compressed format. The server optionally resizes images using an image processing library and transcodes videos using a multimedia processing library to match the resolution and decoding capabilities of the terminal. The server sends the processed content to the terminal through the network interface. The terminal displays the content on the display along with the interactive three-dimensional view. In this way, the generative AI model is integrated into a pipeline where the computational kernel-prompt sentence generation and layout optimization is tightly coupled with the system's internal state and with the user's emotion state. The server uses feedback from the user to further refine internal models. The terminal prompts the user to rate generated simulations and optionally enter comments about clarity or perceived stress. The terminal transmits these ratings, along with identifiers for the associated prompt sentence and generated content, to the server. The server stores these feedback records together with emotion state records and layout information. Periodically, the server trains or re-trains the psychological load index model and the prompt selection policy using these datasets. The server constructs training samples in which candidate layouts and simulation properties are paired with user ratings and emotion changes. The server uses these samples to update model parameters via backpropagation and appropriate loss functions, such as mean squared error between predicted and observed ratings or cross-entropy between predicted and observed prompt selection effectiveness. This training process allows the server to improve prediction accuracy of psychological load and to select templates that yield higher-rated simulations.

The combination of layout optimization, emotion estimation, and prompt sentence control yields technical effects beyond simple automation of human planning tasks. The server actively modifies internal optimization criteria based on predicted psychological metrics, thereby reducing iterations in which the user rejects or cannot interpret a layout. As a result, the number of server-terminal round trips is reduced, which decreases network traffic and server CPU load.

Additionally, the server reduces the volume of displayed data when confusion is high, which decreases rendering load and improves interactive frame rates on resource-constrained terminals. The neural network-based emotion estimation and psychological load prediction shift complexity from manual rule tuning toward data-driven modeling, which allows the system to adapt to new usage patterns without redesigning core logic.

The described architecture provides several alternative configurations. In one variation, the server performs some facial and audio feature extraction locally on the terminal using a lightweight model to reduce bandwidth, transmitting only high-level features instead of raw media, thus lowering communication load. In another variation, the server uses a different optimization solver or heuristic algorithm, such as simulated annealing or evolutionary algorithms, but still incorporates psychological load indices in the objective function. In yet another variation, the generative AI model generates schematic diagrams rather than photorealistic images, depending on the selected template attributes, but uses the same prompt sentence generation engine. In all variations, the core concept remains that the server integrates environmental modeling, planning, emotion-aware optimization, and generative simulation control into a unified computational pipeline that improves the technical performance of the system in terms of calculation efficiency, accuracy of layout suitability, quality of user comprehension, and reduction of unnecessary computation and communication.

The user operates the system through the terminal to specify environment, planning, and simulation requests, but the server performs non-conventional processing that differs from manual planning by humans. The server constructs and solves multi-objective optimization problems including non-intuitive psychological terms, executes deep learning models for emotion and load prediction, and generates adapted prompt sentences that would not be practically manageable without automated computation. Thus, the system as a whole provides an improved computer-based tool that enhances operation of the underlying hardware and software resources, rather than merely computerizing an existing human workflow.

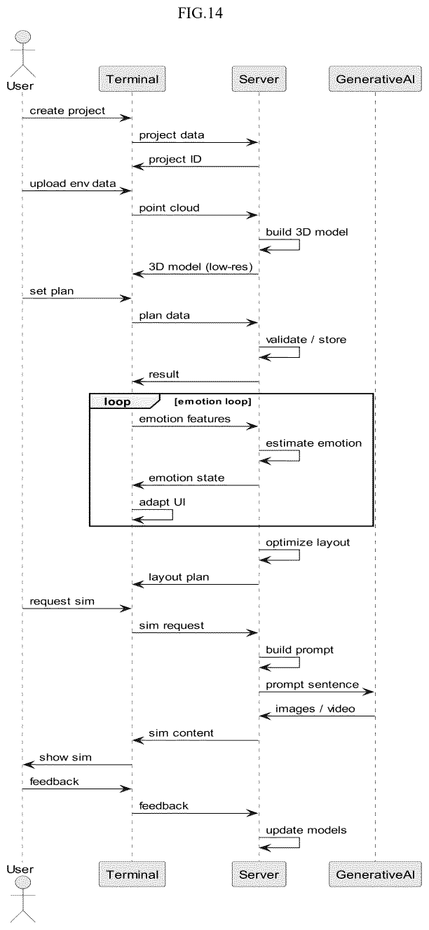

The following describes the processing flow using FIG. 14.

### Step 1:

The terminal displays a project creation screen and receives, as input, user entries including a project name, a physical site address, and a planned work period.

The terminal converts the user-entered strings and dates into a structured data record, for example a key-value map representing project attributes. The terminal appends a terminal identifier and a user identifier to this record. The terminal outputs a project creation request by transmitting this structured data record to the server through a network connection.

### Step 2:

The server receives, as input, the project creation request containing basic project attributes, the terminal identifier, and the user identifier.

The server validates the received fields (for example, checking that dates are in chronological order and that mandatory fields are not empty) and performs a data transformation that maps the logical fields to columns of a project table in a database. The server then executes a database operation that generates a new project identifier, for example by invoking a sequence generator, and inserts a new row containing the project identifier and the project attributes. The server outputs a project creation response containing at least the generated project identifier and a success status.

### Step 3:

The terminal receives, as input, the project creation response including the project identifier.

The terminal stores the project identifier in a local storage element and updates its internal context so that subsequent operations are associated with this project identifier. The terminal outputs a project context state that includes the active project identifier, which will be attached to later requests to the server.

### Step 4:

The user operates the terminal to request registration of environmental information for the active project. The user selects options for uploading point cloud data, photos, or entering coordinates. The terminal receives, as input, the user's selection and any local file references, such as a path to a point cloud file captured by a measurement device. The terminal reads file metadata and constructs an upload request that combines the project identifier, file type, and file content. The terminal outputs this upload request by transmitting a multipart or binary payload to the server.

### Step 5:

The server receives, as input, the environmental data upload request, including the project identifier and binary file content.

The server writes the received file to a non-volatile storage path that is associated with the project identifier, and records the path, file type, and upload time in an environmental data table in the database. The server outputs a registration result containing a reference to the stored file and a confirmation status, which can be used by later processing modules.

### Step 6:

The server retrieves, as input, the stored file reference for point cloud data associated with the project identifier.

The server uses a three-dimensional point cloud processing library to load the point cloud data into memory as a dense array of three-dimensional coordinates. The server performs data processing operations including outlier removal, downsampling, and coordinate normalization, using statistical and geometric algorithms provided by the library. The server then executes a surface reconstruction algorithm to build a triangular mesh representing terrain, and computes vertex attributes such as elevation and normal vectors using vector arithmetic. The server outputs terrain mesh data stored as structured records in a terrain table or as a serialized mesh object.

### Step 7:

The server receives, as input, geographic coordinates of the project site, either from project records or from terminal inputs.

The server sends these coordinates to an external mapping service and receives surrounding environment information including building outlines and road paths. The server applies matrix-based coordinate transformations to align the external coordinates with the local terrain mesh coordinate system. The server merges this transformed environment information with the terrain mesh data into a combined three-dimensional model data structure. The server outputs a downsampled version of this three-dimensional model data suitable for rendering on the terminal and stores a full-resolution version for server-side computations.

### Step 8:

The terminal receives, as input, the downsampled three-dimensional model data from the server.

The terminal loads this data into a three-dimensional rendering engine and constructs a scene graph representing terrain and surrounding structures. The terminal configures a virtual camera and lighting parameters and renders an initial view on the display. The terminal outputs an interactive visualization that responds to user gestures.

### Step 9:

The user interacts with the terminal by rotating, panning, and zooming the view, and by tapping on specific areas to indicate candidate resource locations, such as temporary storage areas or restricted zones

The terminal receives, as input, touch coordinates corresponding to a user tap on the display. The terminal uses the rendering engine's camera matrices to perform a ray casting operation from the camera viewpoint through the screen point into the scene. The terminal computes an intersection point between the ray and the terrain mesh, thereby obtaining a three-dimensional coordinate in the model space. The terminal constructs a candidate location record containing this coordinate, the candidate type, and the project identifier. The terminal outputs this candidate location record to the server.

### Step 10:

The server receives, as input, the candidate location record including the three-dimensional coordinate, candidate type, and project identifier.

The server inserts this information into a candidate location table and links it with the existing three-dimensional model data for the project. The server may compute additional attributes, such as nearest road segment or distance to key structures, using spatial queries. The server outputs an updated environment state, in which candidate locations are registered for use by layout planning logic.

### Step 11:

The user uses the terminal to input planning information such as work stages, schedule data, material requirements, machine allocations, and worker counts.

The terminal receives, as input, this planning information via form fields and interactive widgets. The terminal composes a structured planning record containing an array or list of stages, each with associated requirements and temporal attributes, and attaches the project identifier. The terminal outputs a planning information request to the server.

### Step 12:

The server receives, as input, the planning information request containing at least one stage definition, resource requirements, and the project identifier.

The server validates and normalizes the received data by splitting it into relational tables for stages, materials, machines, and workers. The server then applies rule-based checks by feeding the normalized data into a rule engine, which evaluates predicates that represent safety constraints, temporal constraints, and regulatory conditions. The server generates violation records if any rules are not satisfied and packages these as diagnostic messages. The server outputs either a success response indicating valid planning information or a validation report detailing detected violations.

### Step 13:

The terminal receives, as input, the validation report from the server.

The terminal parses the report and maps each violation to corresponding user interface elements, such as the stages or fields that caused the issue. The terminal visually highlights these fields and displays explanatory messages on the screen, enabling the user to correct the input. The terminal outputs corrected planning information records when the user resubmits adjusted data.

### Step 14:

The terminal, while the user is interacting with planning or visualization screens, acquires, as input, raw sensor data such as face images from the imaging device, audio signals from the voice acquisition device, and interaction logs from input events.

The terminal processes these inputs by extracting facial landmarks, computing audio features, and summarizing interaction patterns into feature vectors. The terminal normalizes and aggregates the features into emotion estimation feature quantities. The terminal outputs these feature quantities to the server as emotion-related data packets, with timestamps and identifiers.

### Step 15:

The server receives, as input, the emotion estimation feature quantities from the terminal. The server passes these features through a multimodal neural network that applies learned weights to each modality and computes activations through convolutional, recurrent, and dense layers. The server obtains raw emotion scores for a set of emotion categories and converts these scores into probabilities using a softmax operation. The server selects a dominant emotion and determines an intensity from the corresponding probability. The server records these values as an emotion state in an emotion state table and outputs the current emotion state to the terminal as part of a user context.

### Step 16:

The terminal receives, as input, the current emotion state from the server.

The terminal maps emotion categories and intensities to display policies; for example, an anxious state triggers a safety-focused mode and a confused state triggers a simplified mode. The terminal applies these policies by modifying user interface configuration parameters such as visible panels, text verbosity, and color schemes. The terminal recomputes layout of widgets and re-renders three-dimensional views with additional overlays for risks or safe paths. The terminal outputs an adapted user interface that is synchronized with the emotion state.

### Step 17:

The server receives, as input, the finalized planning information, candidate locations, and the combined three-dimensional model data for the project.

The server constructs an optimization model in which decision variables represent resource placement coordinates and route selection flags. The server calculates objective terms, including travel distances and resource handling costs, using geometric computations on the three-dimensional model. The server also constructs a feature vector describing expected psychological complexity of candidate layouts, such as counts of turns on worker routes and proximity of paths to hazardous areas. The server feeds this feature vector into a psychological load index model that outputs predicted confusion and anxiety scores. The server adds these scores as weighted penalty items to the objective function. The server then calls an optimization solver to minimize the objective subject to constraints like collision avoidance and safety margins, and receives an optimized solution specifying resource placement and route selections. The server outputs a layout plan composed of placement positions and movement routes.

### Step 18:

The terminal receives, as input, the layout plan from the server.

The terminal integrates this plan into its three-dimensional scene by instantiating or repositioning three-dimensional models of materials, machines, and other resources at the specified coordinates. The terminal also renders route indicators, such as arrows or colored lines, corresponding to movement routes. The terminal updates its internal mapping from rendered objects to logical identifiers so that interactions such as taps can reveal detailed properties. The terminal outputs a three-dimensional visualization that depicts the generated layout plan in a form that the user can inspect and explore.

### Step 19:

The user examines the three-dimensional visualization on the terminal and, if needed, requests a simulation based on a generative AI model by selecting options such as “safety simulation,” “efficiency simulation,” or “step-by-step explanation.”

The terminal receives, as input, the user's simulation request along with the current project identifier and selected emphasis mode. The terminal constructs a simulation request object that includes these values and sends it to the server. The terminal outputs this request for server-side processing

### Step 20:

The server receives, as input, the simulation request containing the project identifier and emphasis mode.

The server retrieves the current three-dimensional model data, layout plan, planning information, and latest emotion state from the database. The server evaluates the emphasis mode and the emotion state to select one of several stored prompt templates tagged with attributes such as safety emphasis, efficiency emphasis, and ease-of-understanding emphasis. The server fills placeholders in the selected template using text constructed from current site conditions, layout summaries, and stage descriptions. The server produces a complete prompt sentence describing what kind of visual content the generative AI model should generate. The server outputs this prompt sentence as a generative request to the generative AI model.

### Step 21:

The server supplies, as input, the generated prompt sentence and generation parameters, such as image resolution and number of frames, to the generative AI model.

The server executes or invokes the generative AI model, which encodes the prompt sentence into a textual embedding and iteratively generates a visual representation through a neural network, for example using a diffusion-based process. The server receives the output image or video data and may further process it by resizing or transcoding to meet terminal requirements. The server links this content with the originating prompt sentence and simulation request. The server outputs the processed generative content to the terminal.

### Step 22:

The terminal receives, as input, the generative content from the server, such as images or a video representing the requested simulation.

The terminal displays the images as selectable thumbnails or plays the video using an integrated media player, optionally overlaying controls for pausing, seeking, or switching views. The terminal can also superimpose additional interactive elements, such as labels or icons, over the generative content to align it with the underlying three-dimensional model. The terminal outputs a combined simulation display that enables the user to view both the layout plan and the generative visualization.

### Step 23:

The user observes the simulation and provides feedback via the terminal by entering ratings, selecting predefined labels, or typing comments regarding clarity, perceived safety, or usefulness.

The terminal receives, as input, this feedback along with implicit context including the prompt sentence identifier and generative content identifier. The terminal bundles these values into a feedback record and sends it to the server. The terminal outputs a feedback data packet referencing the simulation and the user's evaluation.

### Step 24:

The server receives, as input, the feedback data packet from the terminal.

The server writes the feedback into a feedback table linked to the associated prompt sentence, generative content, layout plan, and emotion state at the time of viewing. The server uses accumulated feedback records as training data for periodic model updates. In particular, the server constructs datasets where psychological load predictions and prompt selection decisions are paired with user ratings, and uses these datasets to re-train the psychological load index model and to refine template selection logic. The server updates neural network parameters using gradient-based learning and deploys these updated models in memory for subsequent processing.

The server outputs improved model parameters and selection policies that will influence future layout generation, emotion estimation, and prompt sentence generation.

The data generation model 58 is a so-called generative artificial intelligence (AI). Examples of the data generation model 58 include generative Als such as ChatGPT (registered trademark) (Internet search<URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent.

Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

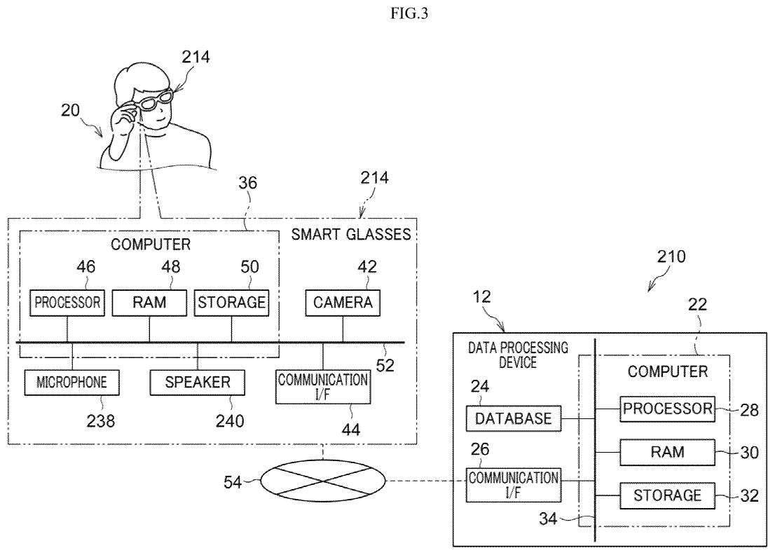

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

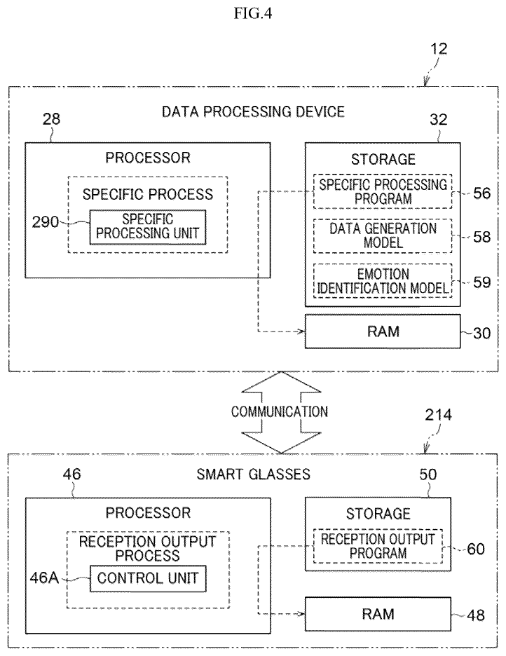

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search<URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent.

Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

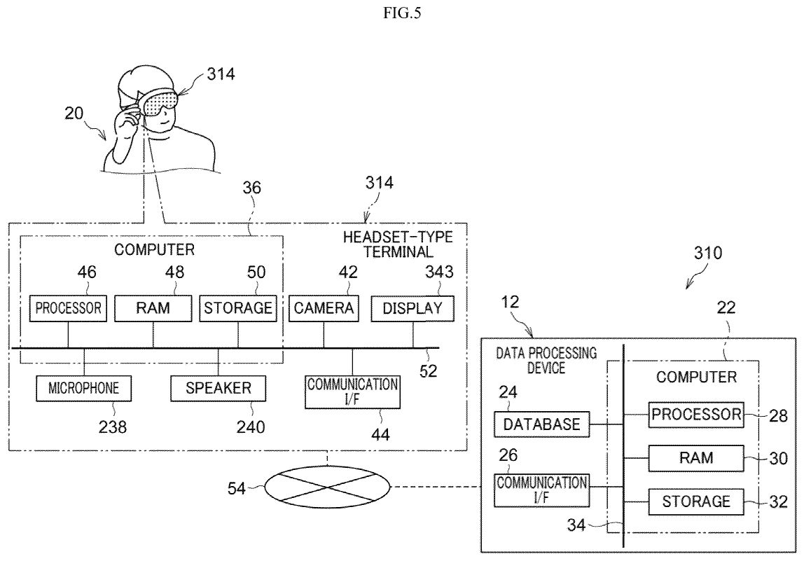

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

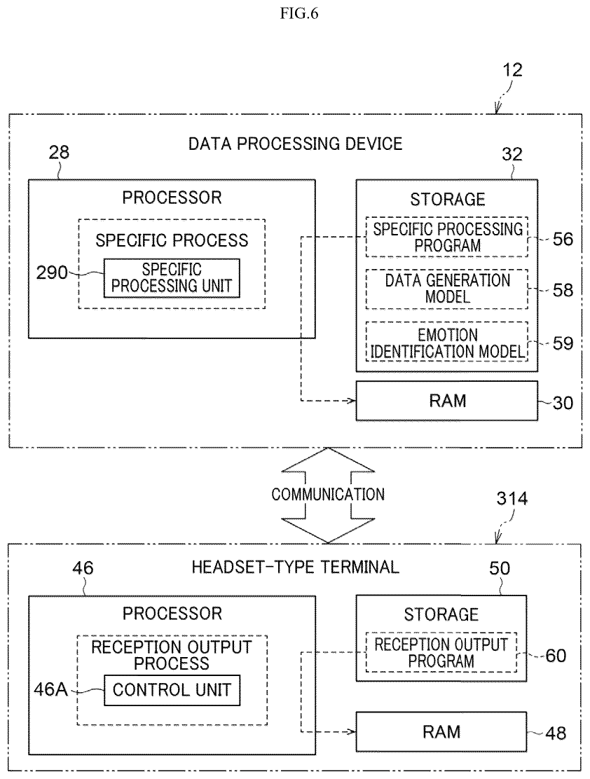

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above. The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search<URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user.

Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

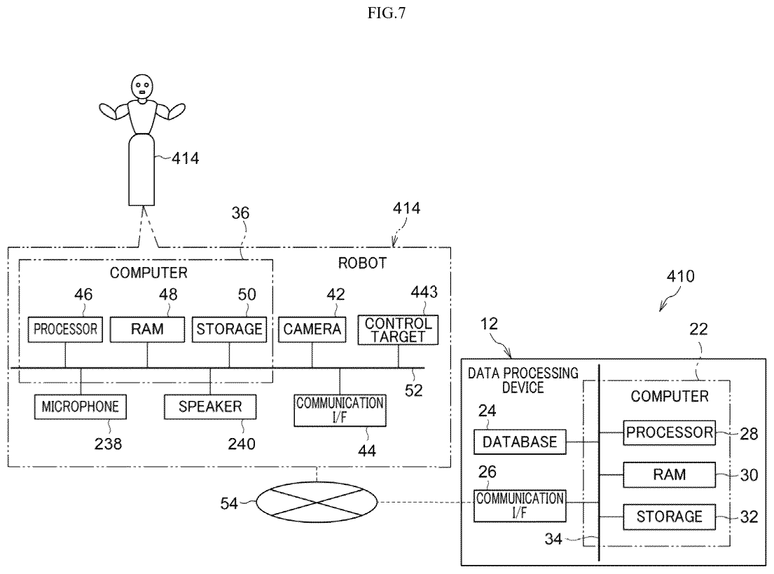

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

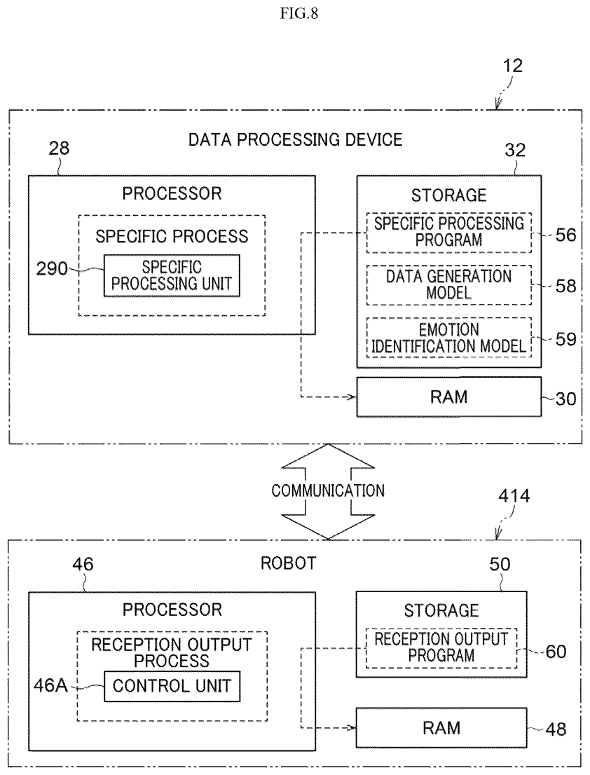

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12.

The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search<URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

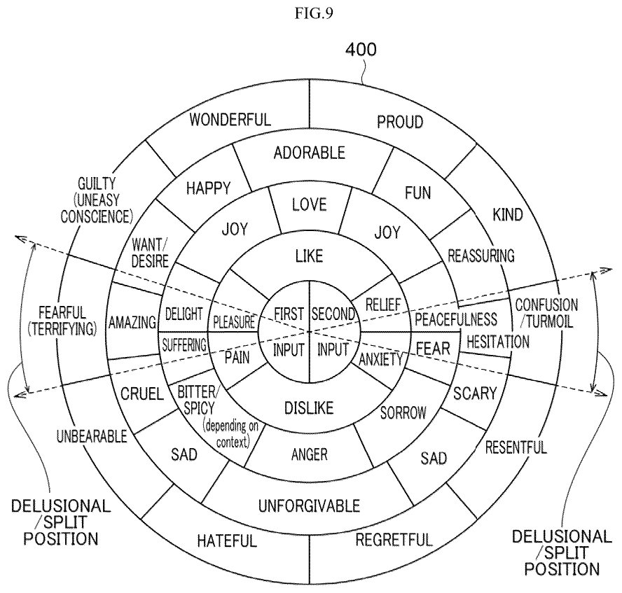

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states.

Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

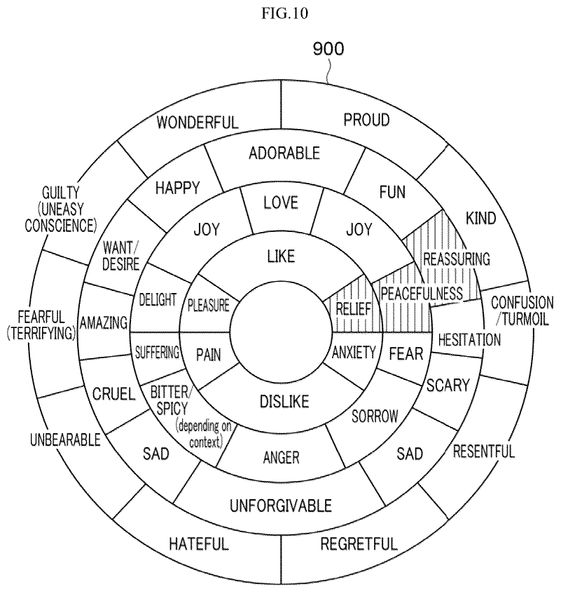

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (Saas).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,
wherein the processor is configured to
acquire site attribute information including environmental information from a user, and generate site attribute data including position information and surrounding environment information by using a position information acquisition device and a map information acquisition device,
acquire regulatory condition information and habitation requirement information from the user, and generate design constraint data by using the regulatory condition information and the habitation requirement information,
input the site attribute data and the design constraint data to a search process including an evolutionary computation process and a machine learning process, calculate a plurality of layout candidates, and calculate a suitability score for each layout candidate on the basis of an evaluation index to extract at least one selected layout candidate,
generate solid shape data on the basis of the at least one selected layout candidate, generate three-dimensional model data representing a building space by using the solid shape data, and provide the three-dimensional model data to a display terminal,
and acquire evaluation information and correction condition information for the at least one selected layout candidate from the user, and re-execute the search process on the basis of the evaluation information and the correction condition information to update the plurality of layout candidates.

### (Supplementary 2)

The system according to supplementary 1,
wherein the processor is configured to
obtain, on the basis of attribute information relating to building finish materials stored in a material information storage device, candidates relating to wall finish materials and floor finish materials, present the candidates to the user, acquire selection operations of the wall finish materials and the floor finish materials from the user, and associate attribute information corresponding to the selected finish materials with the three-dimensional model data, apply the attribute information to the three-dimensional model data, generate updated three-dimensional model data in which the finish materials are reflected, and cause the updated three-dimensional model data to be visually displayed.

### (Supplementary 3)

The system according to supplementary 1,
wherein the processor is configured to
acquire a prompt sentence including an instruction sentence obtained by a text input operation from the user,
input the prompt sentence, spatial configuration information included in the three-dimensional model data, and finish material attribute information as input conditions to a generative artificial intelligence model, and cause the generative artificial intelligence model to generate interior representation image data including furniture arrangement and color composition, and present the generated interior representation image data to the display terminal, acquire evaluation information and a correction prompt sentence from the user, update the input conditions for the generative artificial intelligence model on the basis of the evaluation information and the correction prompt sentence, and regenerate the interior representation image data.

### Application Example 1

### (Supplementary 1)

A system comprising a processor,
wherein the processor is configured to
receive environment information including land information; and set design conditions and work conditions; and
calculate a resource arrangement and a movement path plan based on the environment information and the design conditions; and
generate three-dimensional spatial information representing the resource arrangement and the movement path plan and convert the three-dimensional spatial information into visualization data; and
generate, based on the visualization data, a prompt sentence and associated condition data to be input to a generative AI model; and
generate image information or video information by using the generative AI model on the basis of the prompt sentence and the associated condition data; and
output the generated image information or the generated video information as verification information for the resource arrangement and the movement path plan; and analyze, in response to an instruction from a user, the generated image information or the generated video information, convert a result of the analysis into structured data of the resource arrangement and the movement path plan, and update the resource arrangement and the movement path plan based on the structured data.

### (Supplementary 2)

The system according to supplementary 1,
wherein the processor is configured to
automatically add numerical information and constraint information relating to the environment information, the design conditions, the resource arrangement, and the movement path plan to the prompt sentence to generate an expanded prompt sentence, and generate input data for the generative AI model by combining the expanded prompt sentence with structured time-series work information and three-dimensional spatial information.

### (Supplementary 3)

The system according to supplementary 1,
wherein the processor is configured to
extract features corresponding to a resource arrangement region, a movement route, and equipment placement from the image information or the video information output from the generative AI model, associate the extracted features with the three-dimensional spatial information and the resource arrangement and the movement path plan, register an alternative plan proposed by the generative AI model as version-managed planning data, and enable adoption or rejection of the alternative plan in response to a selection by a user.

### Example 2

### (Supplementary 1)

A system comprising a processor,
wherein the processor is configured to
acquire land information including at least a size, a shape, and an orientation of a site,
acquire design condition information including at least required facilities, regulatory conditions, and other planning conditions for a building,
generate a plurality of building layout proposals on the basis of the land information and the design condition information, and generate three-dimensional model data for each of the plurality of building layout proposals,
cause a display device to display the three-dimensional model data, and acquire, as operation history information, viewpoint operations and display time of a user with respect to a building layout proposal displayed on the display device,
acquire image information and audio information related to the user from an imaging device and an audio acquisition device, and output the image information and the audio information in association with the operation history information,
apply a machine learning model to the image information and the audio information to estimate an emotional state of the user with respect to each of the building layout proposals or with respect to an interior proposal based on each of the building layout proposals, extract, as feature quantities, attribute information related to each of the building layout proposals and the interior proposals, the attribute information including at least an opening area, a ceiling height, a storage amount, a surface finish type, a color characteristic, and a furniture arrangement amount,
calculate preference parameters including, for respective preference elements comprising at least brightness, wood texture feeling, storage amount, and openness, weights of the respective preference elements, on the basis of the emotional state and the feature quantities, update weight values of an evaluation function used when generating the building layout proposals, in accordance with the preference parameters, to thereby adjust building layout proposals generated subsequently,
generate or correct a generation instruction prompt sentence, to be input to a generative artificial intelligence model, on the basis of the design condition information and the preference parameters,
input the prompt sentence and condition information including at least one of the three-dimensional model data and a layout image to the generative artificial intelligence model, and generate an interior image including at least furniture arrangement, color planning, and lighting planning, and
cause the display device to present the interior image, and acquire additional operation history information and the emotional state with respect to the interior image during presentation, and update the preference parameters on the basis of the additional operation history information and the emotional state.

### (Supplementary 2)

The system according to supplementary 1,
wherein the processor is configured to
apply interior finish material information to the three-dimensional model data,
cause a list of the interior finish material information to be displayed and accept a selection operation by the user, and
assign, in response to the selection operation, material information and texture information corresponding to wall surfaces, floor surfaces, and ceiling surfaces to the three-dimensional model data, and cause updated three-dimensional model data to be redisplayed on the display device.

### (Supplementary 3)

The system according to supplementary 1,
wherein the processor is configured to
record, in time series, the emotional state and the operation history information in association with identification information of each of the building layout proposals or each of the interior images, and
sequentially update a word composition, a style specification, and constraint conditions of the generated prompt sentence on the basis of the recorded information, and generate a personalized prompt sentence for each user.

### Application Example 2

### (Supplementary 1)

A system comprising a processor,
wherein the processor is configured to function as an environmental information input unit, a planning information setting unit, a three-dimensional model generation unit, a layout plan generation unit, an emotion-related information acquisition unit, an emotion state estimation unit,
a user interface control unit, a prompt sentence generation unit for a generative AI model, and a simulation presentation unit,
wherein the processor, functioning as the environmental information input unit, is configured to acquire location information, shape information, and surrounding situation information relating to a physical space, and to input terrain information and surrounding environment information of the physical space based on the acquired information,
wherein the processor, functioning as the planning information setting unit, is configured to receive input of schedule information, resource information, and safety condition information relating to work to be executed in the physical space, and to store the received information as planning information,
wherein the processor, functioning as the three-dimensional model generation unit, is configured to generate three-dimensional model data representing the physical space based on the terrain information and the surrounding environment information acquired by the environmental information input unit,
wherein the processor, functioning as the layout plan generation unit, is configured to automatically generate, by mathematical optimization processing or search processing, a layout plan including placement positions and movement routes of resources in the physical space based on the three-dimensional model data and the planning information, and is further configured to use a psychological load index as an evaluation function or a constraint condition so as to determine the layout plan such that confusion, anxiety, or irritation of a user is reduced,
wherein the processor, functioning as the emotion-related information acquisition unit, is configured to acquire facial expression information, voice information, and operation information from a terminal device including a display device, an imaging device, a voice acquisition device, and an operation history acquisition device, to perform preprocessing on the acquired information to generate emotion estimation feature quantities, and to transmit the emotion estimation feature quantities to a server device,
wherein the processor, functioning as the emotion state estimation unit, is configured to use a machine learning model to estimate an emotion state including at least one of reassurance, confusion, anxiety, and irritation, and an intensity thereof, from the emotion estimation feature quantities, and to hold the estimated emotion state as an internal state,
wherein the processor, functioning as the user interface control unit, is configured to dynamically change at least one of a layout of a display screen, a detail level of display information, a highlight region, and an amount or expression level of explanatory text in accordance with the emotion state estimated by the emotion state estimation unit, and to control a presentation mode of the layout plan and the planning information,
wherein the processor, functioning as the prompt sentence generation unit for the generative AI model, is configured to automatically generate a prompt sentence describing generation conditions to be input to the generative AI model based on the three-dimensional model data, the layout plan, the planning information, and the emotion state, to select a template having an attribute of at least one of safety emphasis, efficiency emphasis, and ease-of-understanding emphasis from among a plurality of templates in accordance with the emotion state and the planning information, and to dynamically modify contents of the prompt sentence by embedding conditions of the physical space, key points of the layout plan, and schedule information into the selected template,
and wherein the processor, functioning as the simulation presentation unit, is configured to obtain image data or video data generated by the generative AI model to which the prompt sentence is input, and to present the image data or the video data to the terminal device in combination with an interactive display based on the three-dimensional model data.

### (Supplementary 2)

The system according to supplementary 1,
wherein the processor, functioning as the prompt sentence generation unit for the generative AI model, is configured to generate a prompt sentence that emphasizes description of hazardous regions, evacuation routes, and safety precautions when the emotion state indicates anxiety or confusion, to generate a prompt sentence that concisely describes only main placement relationships and movement routes when the emotion state indicates irritation and a confusion level is low, and to generate a prompt sentence that explains step-by-step procedures for respective stages when the emotion state indicates learning intention or insufficient understanding.

### (Supplementary 3)

The system according to supplementary 1,
wherein the processor, functioning as the layout plan generation unit, is configured to use a psychological load index model constructed by using, as learning data, an emotion state history acquired in the past, evaluation information relating to generated content presented by the simulation presentation unit, and correspondence between the evaluation information and the prompt sentence, to incorporate predicted confusion, anxiety, or irritation obtained from the psychological load index model into an objective function or a constraint condition when generating the layout plan, and to derive the layout plan in which both physical efficiency and reduction of psychological load are taken into account.

What is claimed is:

1. A system comprising:
circuitry configured to:
receive, via a communication interface coupled to a packet-switched network, site attribute data including position information and spatial dimension data from a terminal device;
receive constraint data specifying design requirements from the terminal device;
input the site attribute data and the constraint data to an optimization process including an evolutionary computation process and a machine learning process to generate a plurality of layout candidates and calculate a suitability score for each layout candidate based on an evaluation index;
generate three-dimensional model data representing spatial configurations based on at least one selected layout candidate; and
transmit the three-dimensional model data to the terminal device via the communication interface.

2. The system according to claim 1, wherein the site attribute data includes at least a size, a shape, and an orientation of a land parcel, and wherein the circuitry generates the site attribute data by querying a map information service via the packet-switched network to obtain surrounding environment information associated with the position information.

3. The system according to claim 2, wherein the constraint data includes regulatory condition information specifying zoning and building code parameters, and habitation requirement information specifying required facilities and spatial allocation preferences input by a user via the terminal device.

4. The system according to claim 3, wherein the circuitry generates the design constraint data by encoding the regulatory condition information and the habitation requirement information into a structured data format including numerical bounds, categorical restrictions, and tolerance degree parameters for each constraint.

5. The system according to claim 4, wherein the evolutionary computation process includes a genetic algorithm that generates an initial population of layout candidates from the constraint data, applies crossover and mutation operations to produce successive generations, and evaluates each layout candidate against the evaluation index including spatial efficiency, regulatory compliance, and requirement satisfaction scores.

6. The system according to claim 1, wherein the circuitry generates solid shape data from the at least one selected layout candidate and constructs the three-dimensional model data by extruding the solid shape data into volumetric representations of spatial partitions with associated dimensional attributes.

7. The system according to claim 6, wherein the circuitry retrieves material attribute data from a material information storage coupled to the packet-switched network, presents material candidates for surface finishes to the terminal device, receives material selection data from the terminal device, and associates the selected material attribute data with corresponding surfaces in the three-dimensional model data.

8. The system according to claim 7, wherein the circuitry generates updated three-dimensional model data in which the selected material attributes including texture, color, and reflectivity properties are applied to the corresponding surfaces, and transmits the updated three-dimensional model data to the terminal device for rendering.

9. The system according to claim 1, wherein the circuitry receives prompt data from the terminal device including instruction text specifying design preferences, and constructs input conditions by combining the prompt data, spatial configuration information from the three-dimensional model data, and material attribute information.

10. The system according to claim 9, wherein the circuitry transmits the input conditions to a generative neural network model comprising an image generation architecture, and receives interior representation image data from the generative neural network model, the interior representation image data including synthesized imagery with furniture arrangement and color composition.

11. The system according to claim 10, wherein the circuitry receives evaluation data and correction prompt data from the terminal device, updates the input conditions based on the evaluation data and the correction prompt data, retransmits the updated input conditions to the generative neural network model, and regenerates the interior representation image data.

12. The system according to claim 1, wherein the circuitry is further configured to calculate cost estimation data for each layout candidate based on spatial dimensions, selected material quantities, and unit cost data stored in the storage device, and to include the cost estimation data in the suitability score calculation.

13. The system according to claim 12, wherein the circuitry applies a multi-objective optimization to the plurality of layout candidates to identify a Pareto-optimal set balancing the suitability score, the cost estimation data, and energy efficiency metrics derived from the site attribute data including orientation and surrounding environment information.

14. The system according to claim 1, wherein the circuitry is further configured to perform structural feasibility analysis on each layout candidate by evaluating load distribution based on spatial partition dimensions and material properties, and to exclude layout candidates that fail structural feasibility criteria from the plurality of layout candidates.

15. The system according to claim 14, wherein the circuitry performs environmental performance simulation on the selected layout candidate including sunlight exposure analysis based on the orientation data and surrounding environment information, and natural ventilation flow analysis based on spatial partition configurations, and transmits simulation result data to the terminal device.

16. The system according to claim 1, wherein the circuitry is further configured to store each selected layout candidate, associated material selections, and generated image data as versioned project data in the storage device, and to transmit version comparison data to the terminal device enabling side-by-side comparison of layout candidates.

17. The system according to claim 16, wherein the circuitry receives annotation data from a plurality of terminal devices associated with different users, stores the annotation data in association with the versioned project data, and transmits aggregated annotation data to each terminal device to support collaborative design review.

18. A system comprising:
a communication interface including a network interface controller coupled to a packet-switched network and configured to transmit and receive data packets;
a memory storing instructions, an evolutionary computation engine, a machine learning model for layout evaluation, a generative neural network model for image synthesis, material attribute data, and evaluation index parameters; and
circuitry comprising one or more processors coupled to the memory and configured to execute the instructions to:
receive, via the communication interface, site attribute data and constraint data from a terminal device;
input the site attribute data and the constraint data to the evolutionary computation engine and the machine learning model to generate a plurality of layout candidates with suitability scores;
generate three-dimensional model data from at least one selected layout candidate;
retrieve material attribute data, receive material selections from the terminal device, and apply selected material attributes to the three-dimensional model data;
receive prompt data from the terminal device, construct input conditions combining the prompt data and spatial configuration information, transmit the input conditions to the generative neural network model, and receive interior representation image data; and
transmit the three-dimensional model data and the interior representation image data to the terminal device via the communication interface.

19. The system according to claim 18, wherein the circuitry is further configured to receive evaluation data and correction prompt data from the terminal device, update the input conditions, and regenerate the interior representation image data via the generative neural network model.

20. A method performed by circuitry of a server coupled to a packet-switched network via a communication interface, the method comprising:
receiving, via the communication interface, site attribute data including position information and spatial dimension data from a terminal device;
receiving constraint data specifying design requirements from the terminal device;
inputting the site attribute data and the constraint data to an optimization process including an evolutionary computation process and a machine learning process to generate a plurality of layout candidates and calculating a suitability score for each layout candidate based on an evaluation index;
generating three-dimensional model data representing spatial configurations based on at least one selected layout candidate; and
transmitting the three-dimensional model data to the terminal device via the communication interface.
